(19) United States
(12) Patent Application Publication
(10) Pub. No.: US 2014/0116218 A1
(43) Pub. Date: May 1, 2014

(54) PERFORATOR WITH BACKER AND TRANSLATING PERFORATING DEVICES

(71) Applicants: Brian J. Kwarta, Pittsford, NY (US); James Douglas Shifley, Spencerport, NY (US)

(72) Inventors: Brian J. Kwarta, Pittsford, NY (US); James Douglas Shifley, Spencerport, NY (US)

(21) Appl. No.: 13/664,665

(22) Filed: Oct. 31, 2012

(51) Int. Cl. B26F 1/00; B26F 1/20

(52) U.S. Cl. CPC B26F 1/0092; B26F 1/20
USPC 83/425.4; 83/562

(57) ABSTRACT

Apparatus for perforating a moving receiver includes a backer member across a sheet area. Perforating devices each have two perforating wheels selectively pressed towards the backer member. A drive mechanism rotates the backer member or the perforating wheels to perforate the moving receiver. A transport mechanism selectively moves the perforating devices perpendicular to the receiver feed direction. A controller receives a job specification including two or more specified perforation locations and causes the transport mechanism to disengage two or more perforating devices, laterally position them to perforate the moving receiver in the specified perforation locations, and then engage them to perforate.

### CROSS-REFERENCE TO RELATED APPLICATIONS

This application is co-filed with and has related subject matter to U.S. patent application Ser. No. ______, (attorney docket no. K001320), filed herewith, titled “PERFORATOR WITH TRANSLATING PERFORATING DEVICES;” and U.S. patent application Ser. No. ______, (attorney docket no. K001329), filed herewith, titled “RECEIVER-PUNCTURING DEVICE WITH TRANSLATING PUNCTURING DEVICES;” each of which is incorporated herein by reference in its entirety.

This application is related to U.S. Publication No. 2011/0283855, published Nov. 24, 2011, incorporated herein by reference.

### FIELD OF THE INVENTION

This invention pertains to the field of finishing printed sheets, and more particularly to such printed sheets produced using electrophotography.

### BACKGROUND OF THE INVENTION

Customers of print jobs can require finishing steps for their jobs. These steps include, for example, folding printed or blank sheets, cutting sheets and trimming sheets to size and shape. For example, when producing business cards, the cards are printed on a large sheet of stiff card stock. After printing, individual cards are produced by cutting the sheets of cards into individual business cards. In another example, blank sheets of card stock are perforated so that they can be printed and then separated apart.

Conventional finishing equipment is typically not suited for use in consumer occupied environments such as stores or business establishments, and typically requires trained personnel to safely and effectively use it. Cutters typically include large guillotines that use heavy impacts to cut through thick stacks of paper. For example, the INTIMUS PL265 programmable cutter by MARTIN YALE of Wabash, Ind., cuts up to a 2⅞ stack of paper and weighs 823 lbs. There is a need, therefore, for smaller, lighter finishing equipment to incorporate into devices used by consumers at home or in retail environments.

Furthermore, unlike offset presses which run a large number of copies of a single print job, digital printers can produce small numbers of copies of a job, requiring more frequent changes to the finishing sequence. In some cases, each printed page must be finished individually. Moreover, the PL265 cutter can only store 10 cutting programs, so cannot produce more than 10 cut patterns without manual intervention. There is a need, therefore, for flexible and programmable finishing equipment that can finish each page individually without manual intervention.

The CRICUT cutter by PROVO CRAFT can cut shapes into individual sheets of paper. However, the machine requires manual loading and unloading. Furthermore, the CRICUT moves the sheet to be cut back and forth during cutting, making it unsuitable for high-volume applications that need continuous-speed sheet transport.

U.S. Publication No. 2005/0079968 to Trovinger describes a sheet folding and trimming apparatus adapted to fold a sheet, trim three edges of the sheet square with the fold, and assemble the folded and trimmed sheets into a booklet. However, this apparatus trims the sides with fixed cutters not suitable for continuous-web operation.

There is a continuing need, therefore, for a way of flexibly perforating sheets using small, customizable finishers.

### SUMMARY OF THE INVENTION

In accordance with the present invention, there is provided apparatus for perforating a moving receiver comprising:

a backer member extending across a width of a sheet area;

a plurality of perforating devices, each comprising two parallel perforating wheels and an engagement device adapted to selectively press the perforating wheels towards the backer member in a first condition to define two perforating areas and a chad area arranged laterally between the plurality of perforating areas, or to selectively retract the perforating wheels from the backer member in a second condition;

a drive mechanism for rotating the backer member or the perforating wheels of two or more of the plurality of perforating devices so that the rotating perforating wheels engage the moving receiver to perforate the moving receiver parallel to its feed direction in the perforating areas, whereby one or more chads are defined on the moving receiver;

a transport mechanism for selectively moving the plurality of perforating devices perpendicular to the feed direction of the moving receiver, and for controlling the respective engagement devices of each of the plurality of perforating devices; and

a controller for receiving a job specification including two or more specified perforation locations and causing the transport mechanism to:
operate the engagement devices of a selected two or more of the plurality of perforating devices in the second condition; then
laterally position the selected two or more perforating devices to perforate the moving receiver in the two or more specified perforation locations; then
operate the engagement devices of the selected two or more perforating devices in the first condition.

An advantage of this invention is that it uses small, light, inexpensive cutting machinery that can be used in environments without enough space for prior-art machines, or that require unskilled operators be able to use the machinery. Various aspects can emit less audible noise while operating due to its reduced power draw compared to press-style perforators. It can finish each sheet of a print job individually without manual intervention. It can be employed with continuous-feed printing systems.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an elevational cross-section of an electrophotographic reproduction apparatus suitable for use with this invention;

FIGS. 2 and 3 are isometric views of cutting apparatus according to various aspects;

FIGS. 4A and 4B are front and side views, respectively, of a cutting device according to various aspects;

FIG. 5 is a side view of a perforating device according to various aspects;

FIG. 6 is an isometric view of a receiver being perforated according to various aspects;

FIGS. 7A and 7B are side views of perforating wheels according to various aspects;

FIGS. 8A and 8B are front views of portions of a puncturing device according to various aspects;

FIG. 8C is a hypothetical example of a punctured receiver according to aspects shown in FIGS. 8A and 8B;

FIGS. 9-10 are front elevations of apparatus for perforating a moving receiver according to various aspects;

FIG. 11 is a side elevation of the apparatus of FIG. 10 according to various aspects;

FIG. 12 is an axonometric view of apparatus for selectively puncturing a moving receiver according to various aspects;

FIGS. 13-14 are axonometric views of portions of the apparatus of FIG. 12 according to various aspects;

FIG. 15 shows a puncturing device with a sensor according to various aspects;

FIG. 16 shows a hypothetical example of a receiver being perforated by a perforating device; and

FIG. 17 shows portions of apparatus for selectively puncturing a moving receiver according to various aspects.

The attached drawings are for purposes of illustration and are not necessarily to scale.

### DETAILED DESCRIPTION OF THE INVENTION

As used herein, the terms “parallel” and “perpendicular” have a tolerance of ±1°. In various aspects, parallel and perpendicular structures have a tolerance of ±0.17° (±1 mm over 13″), or ±0.07° (±1 mm over 32″).

As used herein, “sheet” is a discrete piece of media, such as receiver media for an electrophotographic printer (described below). Sheets have a length and a width. Sheets are folded along fold axes, e.g. positioned in the center of the sheet in the length dimension, and extending the full width of the sheet. The folded sheet contains two “leaves,” each leaf being that portion of the sheet on one side of the fold axis. The two sides of each leaf are referred to as “pages.” “Face” refers to one side of the sheet, whether before or after folding. “Inboard” refers to closer to the center of a receiver; “outboard” refers to farther from the center of a receiver.

In the following description, some aspects will be described in terms that would ordinarily be implemented as software programs. Those skilled in the art will readily recognize that the equivalent of such software can also be constructed in hardware. Because image manipulation algorithms and systems are well known, the present description will be directed in particular to algorithms and systems forming part of, or cooperating more directly with, methods and systems described herein. Other aspects of such algorithms and systems, and hardware or software for producing and otherwise processing the image signals involved therewith, not specifically shown or described herein, are selected from such systems, algorithms, components, and elements known in the art. Given the system as described in the following, software not specifically shown, suggested, or described herein that is useful for implementation of the invention is conventional and within the ordinary skill in such arts.

A computer program product can include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to various aspects.

Electrophotography is a useful process for printing images on a receiver (or “imaging substrate”), such as a piece or sheet of paper or another planar medium, glass, fabric, metal, or other objects as will be described below.

In this process, an electrostatic latent image is formed on a photoreceptor by uniformly charging the photoreceptor and then discharging selected areas of the uniform charge to yield an electrostatic charge pattern corresponding to the desired image (a “latent image”).

After the latent image is formed, toner particles having a charge substantially opposite to the charge of the latent image are brought into the vicinity of the photoreceptor so as to be attracted to the latent image to develop the latent image into a visible image. Note that the visible image may not be visible to the naked eye depending on the composition of the toner particles (e.g. clear toner).

After the latent image is developed into a visible image on the photoreceptor, a suitable receiver is brought into juxtaposition with the visible image. A suitable electric field is applied to transfer the toner particles of the visible image to the receiver to form the desired print image on the receiver. The imaging process is typically repeated many times with reusable photoreceptors.

The receiver is then removed from its operative association with the photoreceptor and subjected to heat or pressure to permanently fix (“fuse”) the print image to the receiver. Plural print images, e.g. of separations of different colors, are overlaid on one receiver before fusing to form a multi-color print image on the receiver.

Electrophotographic (EP) printers typically transport the receiver past the photoreceptor to form the print image. The direction of travel of the receiver is referred to as the slow-scan or process direction. This is typically the vertical (Y) direction of a portrait-oriented receiver. The direction perpendicular to the slow-scan direction is referred to as the fast-scan or cross-process direction, and is typically the horizontal (X) direction of a portrait-oriented receiver. “Scan” does not imply that any components are moving or scanning across the receiver; the terminology is conventional in the art.

The electrophotographic process can be embodied in devices including printers, copiers, scanners, and facsimiles, and analog or digital devices, all of which are referred to herein as “printers.” Various aspects are useful with electrostatographic printers such as electrophotographic printers that employ toner developed on an electrophotographic receiver, and ionographic printers and copiers that do not rely upon an electrophotographic receiver. Electrophotography and sonography are types of electrostatography (printing using electrostatic fields), which is a subset of electrography (printing using electric fields).

A digital reproduction printing system (“printer”) typically includes a digital front-end processor (DFE), a print engine (also referred to in the art as a “marking engine”) for applying toner to the receiver, and one or more post-printing finishing system(s) (e.g. a UV coating system, a glosser system, or a laminator system). A printer can reproduce pleasing black-and-white or color onto a receiver. A printer can also produce selected patterns of toner on a receiver, which patterns (e.g. surface textures) do not correspond directly to a visible image. The DFE receives input electronic files (such as Postscript command files) composed of images from other input devices (e.g., a scanner, a digital camera). The DFE can include various function processors, e.g. a raster image processor (RIP), image positioning processor, image manipulation processor, color processor, or image storage processor. The DFE rasterizes input electronic files into image bitmaps for the print engine to print. In some aspects, the DFE permits a human operator to set up parameters such as layout, font, color, paper type, or post-finishing options. The print engine takes the rasterized image bitmap from the DFE and renders the bitmap into a form that can control the printing process from the exposure device to transferring the print image onto the receiver. The finishing system applies features such as protection, glossing, or binding to the prints. The finishing system can be implemented as an integral component of a printer, or as a separate machine through which prints are fed after they are printed.

The printer can also include a color management system which captures the characteristics of the image printing process implemented in the print engine (e.g. the electrophotographic process) to provide known, consistent color reproduction characteristics. The color management system can also provide known color reproduction for different inputs (e.g. digital camera images or film images).

In an aspect of an electrophotographic modular printing machine useful with various aspects, e.g. the NEXPRESS 2100 printer manufactured by Eastman Kodak Company of Rochester, N.Y., color-toner print images are made in a plurality of color imaging modules arranged in tandem, and the print images are successively electrostatically transferred to a receiver adhered to a transport web moving through the modules. Colored toners include colorants, e.g. dyes or pigments, which absorb specific wavelengths of visible light. Commercial machines of this type typically employ intermediate transfer members in the respective modules for the transfer to the receiver of individual print images. Of course, in other electrophotographic printers, each print image is directly transferred to a receiver.

Electrophotographic printers having the capability to also deposit clear toner using an additional imaging module are also known. The provision of a clear-toner overcoat to a color print is desirable for providing protection of the print from fingerprints and reducing certain visual artifacts. Clear toner uses particles that are similar to the toner particles of the color development stations but without colored material (e.g. dye or pigment) incorporated into the toner particles. However, a clear-toner overcoat can add cost and reduce color gamut of the print; thus, it is desirable to provide for operator/user selection to determine whether or not a clear-toner overcoat will be applied to the entire print. A uniform layer of clear toner can be provided. A layer that varies inversely according to heights of the toner stacks can also be used to establish level toner stack heights. The respective color toners are deposited one upon the other at respective locations on the receiver and the height of a respective color toner stack is the sum of the toner heights of each respective color. Uniform stack height provides the print with a more even or uniform gloss.

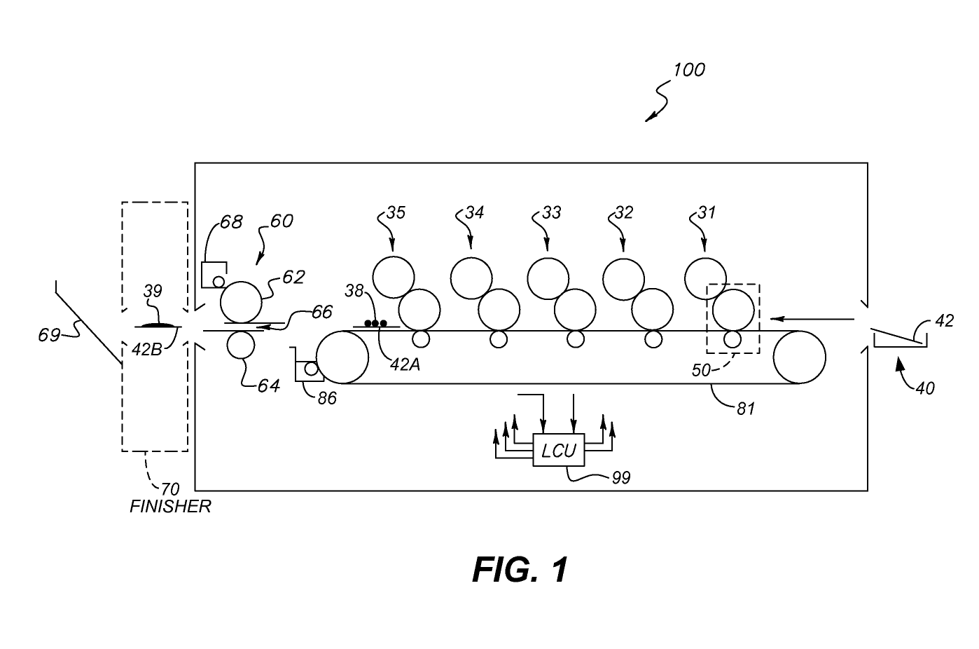

FIG. 1 is an elevational cross-section showing portions of a typical electrophotographic printer 100 useful with various aspects. Printer 100 is adapted to produce images, such as single-color (monochrome), CMYK, or pentachrome (five-color) images, on a receiver (multicolor images are also known as “multi-component” images). Images can include text, graphics, photos, and other types of visual content. One aspect involves printing using an electrophotographic print engine having five sets of single-color image-producing or -printing stations or modules arranged in tandem, but more or less than five colors can be combined on a single receiver. Other electrophotographic writers or printer apparatus can also be included. Various components of printer 100 are shown as rollers; other configurations are also possible, including belts.

Referring to FIG. 1, printer 100 is an electrophotographic printing apparatus having a number of tandemly-arranged electrophotographic image-forming printing modules 31, 32, 33, 34, 35, also known as electrophotographic imaging subsystems. Each printing module produces a single-color toner image for transfer using a respective transfer subsystem 50 (for clarity, only one is labeled) to a receiver 42 successively moved through the modules. Receiver 42 is transported from supply unit 40, which can include active feeding subsystems as known in the art, into printer 100. In various aspects, the visible image can be transferred directly from an imaging roller to a receiver, or from an imaging roller to one or more transfer roller(s) or belt(s) in sequence in transfer subsystem 50, and thence to a receiver. The receiver is, for example, a selected section of a web of, or a cut sheet of, planar media such as paper or transparency film.

Each receiver, during a single pass through the five modules, can have transferred in registration thereto up to five single-color toner images to form a pentachrome image. As used herein, the term “pentachrome” implies that in a print image, combinations of various of the five colors are combined to form other colors on the receiver at various locations on the receiver, and that all five colors participate to form process colors in at least some of the subsets. That is, each of the five colors of toner can be combined with toner of one or more of the other colors at a particular location on the receiver to form a color different than the colors of the toners combined at that location. In an aspect, printing module 31 forms black (K) print images, 32 forms yellow (Y) print images, 33 forms magenta (M) print images, and 34 forms cyan (C) print images.

Printing module 35 can form a red, blue, green, or other fifth print image, including an image formed from a clear toner (i.e. one lacking pigment). The four subtractive primary colors, cyan, magenta, yellow, and black, can be combined in various combinations of subsets thereof to form a representative spectrum of colors. The color gamut or range of a printer is dependent upon the materials used and process used for forming the colors. The fifth color can therefore be added to improve the color gamut. In addition to adding to the color gamut, the fifth color can also be a specialty color toner or spot color, such as for making proprietary logos or colors that cannot be produced with only CMYK colors (e.g. metallic, fluorescent, or pearlescent colors), or a clear toner.

Receiver 42A is shown after passing through printing module 35. Print image 38 on receiver 42A includes unfused toner particles.

Subsequent to transfer of the respective print images, overlaid in registration, one from each of the respective printing modules 31, 32, 33, 34, 35, the receiver is advanced to a fuser 60, i.e. a fusing or fixing assembly, to fuse the print image to the receiver. Transport web 81 transports the print-image-carrying receivers to fuser 60, which fixes the toner particles to the respective receivers by the application of heat and pressure. The receivers are serially de-tacked from transport web 81 to permit them to feed cleanly into fuser 60. Transport web 81 is then reconditioned for reuse at cleaning station 86 by cleaning and neutralizing the charges on the opposed surfaces of the transport web 81.

Fuser 60 includes a heated fusing roller 62 and an opposing pressure roller 64 that form a fusing nip 66 therebetween. In an aspect, fuser 60 also includes a release fluid application substation 68 that applies release fluid, e.g. silicone oil, to fusing roller 62. Alternatively, wax-containing toner can be used without applying release fluid to fusing roller 62. Other fusers, both contact and non-contact, can be employed with various aspects. For example, solvent fixing uses solvents to soften the toner particles so they bond with the receiver. Photoflash fusing uses short bursts of high-frequency electromagnetic radiation (e.g. ultraviolet light) to melt the toner. Radiant fixing uses lower-frequency electromagnetic radiation (e.g. infrared light) to more slowly melt the toner. Microwave fixing uses electromagnetic radiation in the microwave range to heat the receivers (primarily), thereby causing the toner particles to melt by heat conduction, so that the toner is fixed to the receiver.

The receivers (e.g. receiver 42B) carrying the fused image (e.g. fused image 39) are transported in a series from the fuser 60 along a path either to a remote output tray 69, or back to printing modules 31 et seq. to create an image on the backside of the receiver, i.e. to form a duplex print. Receivers can also be transported to any suitable output accessory. For example, an auxiliary fuser or glossing assembly can provide a clear-toner overcoat. Printer 100 can also include multiple fusers 60 to support applications such as overprinting, as known in the art.

In various aspects, between fuser 60 and output tray 69, receiver 42B passes through finisher 70. Finisher 70 performs various paper-handling operations, such as folding, stapling, saddle-stitching, collating, and binding.

Printer 100 includes main printer apparatus logic and control unit (LCU) 99, which receives input signals from the various sensors associated with printer 100 and sends control signals to the components of printer 100. LCU 99 can include a microprocessor incorporating suitable look-up tables and control software executable by the LCU 99. It can also include a field-programmable gate array (FPGA), programmable logic device (PLD), microcontroller, or other digital control system. LCU 99 can include memory for storing control software and data. Sensors associated with the fusing assembly provide appropriate signals to the LCU 99. In response to the sensors, the LCU 99 issues command and control signals that adjust the heat or pressure within fusing nip 66 and other operating parameters of fuser 60 for receivers. This permits printer 100 to print on receivers of various thicknesses and surface finishes, such as glossy or matte.

Image data for writing by printer 100 can be processed by a raster image processor (RIP; not shown), which can include a color separation screen generator or generators. The output of the RIP can be stored in frame or line buffers for transmission of the color separation print data to each of respective LED writers, e.g. for black (K), yellow (Y), magenta (M), cyan (C), and red (R), respectively. The RIP or color separation screen generator can be a part of printer 100 or remote therefrom. Image data processed by the RIP can be obtained from a color document scanner or a digital camera or produced by a computer or from a memory or network which typically includes image data representing a continuous image that needs to be reprocessed into halftone image data in order to be adequately represented by the printer. The RIP can perform image processing processes, e.g. color correction, in order to obtain the desired color print. Color image data is separated into the respective colors and converted by the RIP to halftone dot image data in the respective color using matrices, which comprise desired screen angles (measured counterclockwise from rightward, the +X direction) and screen rulings. The RIP can be a suitably-programmed computer or logic device and is adapted to employ stored or computed matrices and templates for processing separated color image data into rendered image data in the form of halftone information suitable for printing. These matrices can include a screen pattern memory (SPM).

Further details regarding printer 100 are provided in U.S. Pat. No. 6,608,641, issued on Aug. 19, 2003, by Peter S. Alexandrovich et al., and in U.S. Publication No. 2006/0133870, published on Jun. 22, 2006, by Yee S. Ng et al., the disclosures of which are incorporated herein by reference.

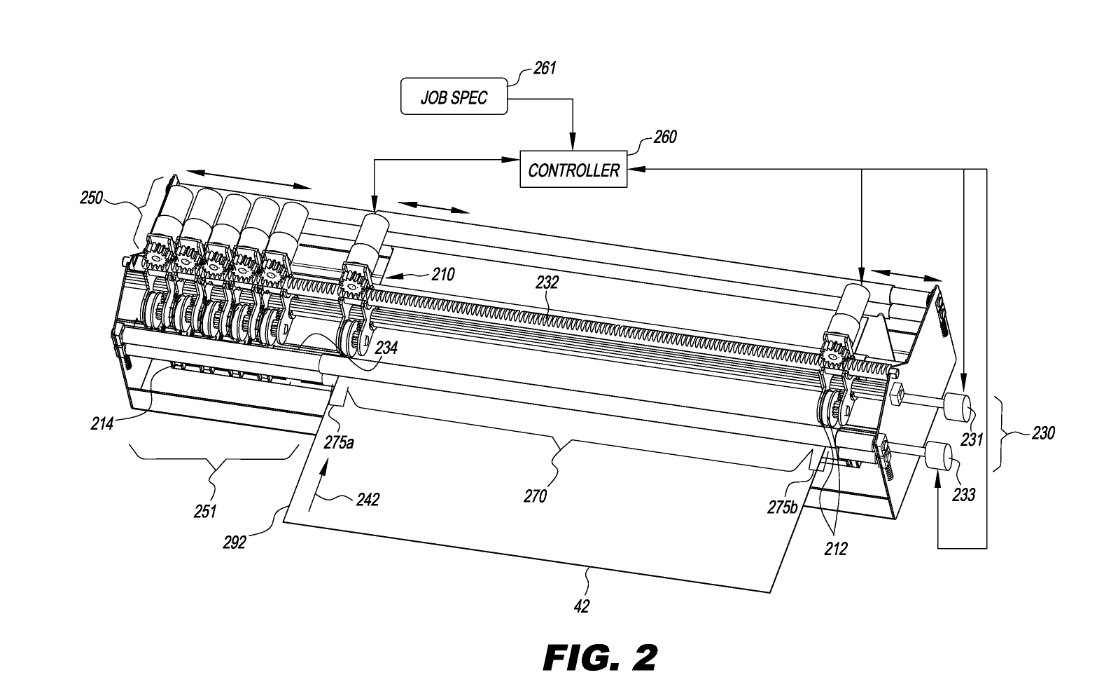

FIG. 2 is an isometric view of cutting apparatus according to an aspect. FIG. 2 shows the apparatus configured for 1-up cutting, in which a narrow edge strip is trimmed of each longitudinal edge. This permits full-bleed output from an electrophotographic printer.

As used herein, “n-up,” for some integer n, refers to cutting receiver 42 into n non-chad sections along cutting axes parallel to the feed direction 242 of receiver 42. This is discussed further below. Non-chad sections are sections intended to be provided to a customer or user of printer 100 (FIG. 1). Chad is intended to be discarded or recycled external to printer 100. The operation of lengthwise cutting is referred to as “slitting.” Between each of the n non-chad sections, and between the outermost two non-chad sections and the corresponding edges of receiver 42, is a chad strip. The chad strips at the edges are the areas of receiver 42 which cannot be printed by a printing module (e.g. printing module 31, FIG. 1). The chad strips not at the edges of receiver 42 remove the areas of receiver 42 between different images to provide clean full-bleed output on each non-chad section. Each non-chad section can have a width the same as or different than the widths of the other non-chad sections.

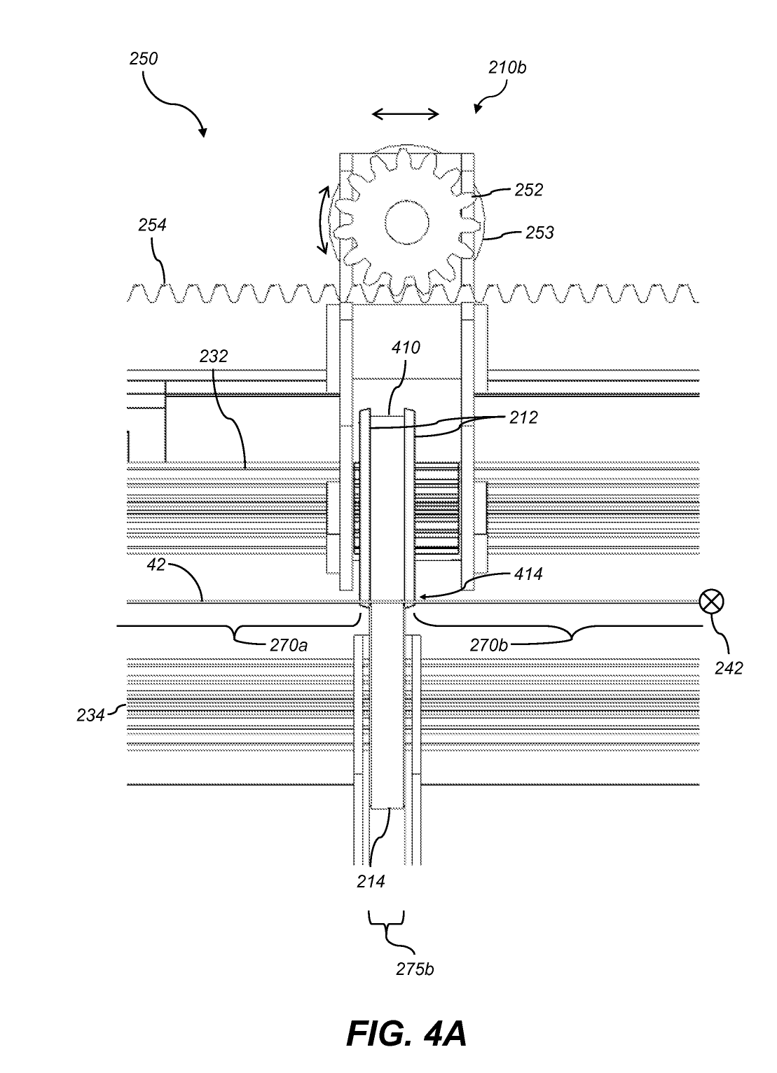

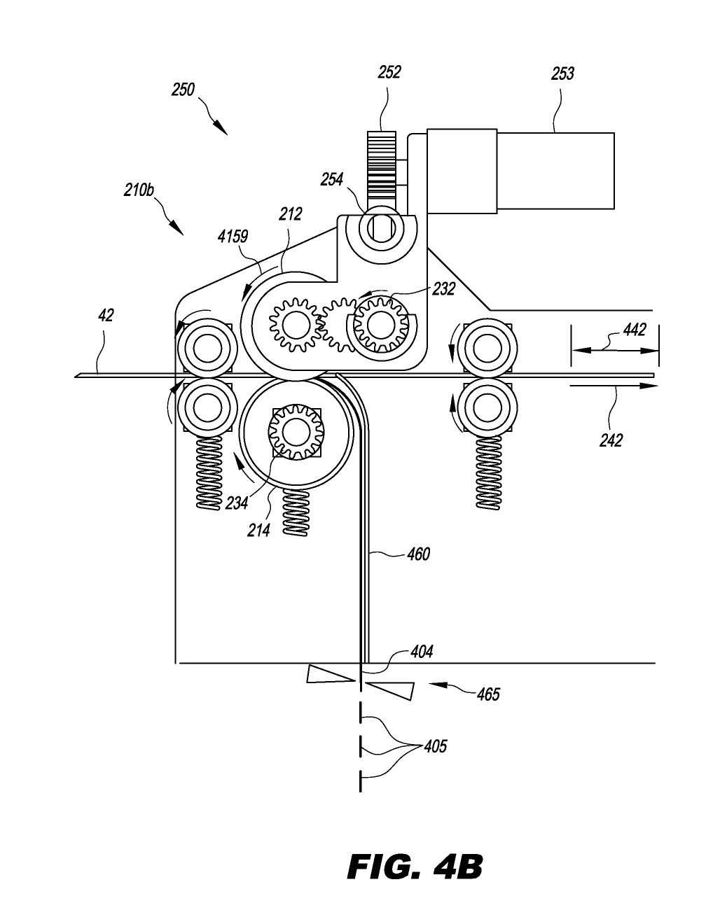

The apparatus for cutting (specifically, slitting, so referred to as a “slitter”) a moving receiver 42 includes a plurality of cutting devices 210, here seven in number. Each cutting device 210 includes two parallel cutting wheels 212 and a pressure wheel 214 arranged so that the cutting wheels 212 are pressed laterally against the pressure wheel 214 to form two cutting areas and a chad area arranged laterally between the cutting areas. This is discussed further below with reference to FIGS. 4A and 4B.

Drive mechanism 230 rotates the cutting wheels 212 or pressure wheel 214 of two or more of the cutting devices 210 so that the rotating cutting wheels 212 engage the moving receiver 42 to cut the moving receiver 42 parallel to its feed direction 242 in the cutting areas. That is, the cutting areas are the portions of receiver 42 that are actually cut, and can be long and narrow in shape. One or more chads are thus cut out of the receiver between the cutting wheels of each cutting device. As shown here, one chad is cut off each edge. The chad can be a long strip of the material of receiver 42. Cutting the strip into smaller pieces for easier waste management is described below with reference to chad chopper 465 (FIG. 4B).

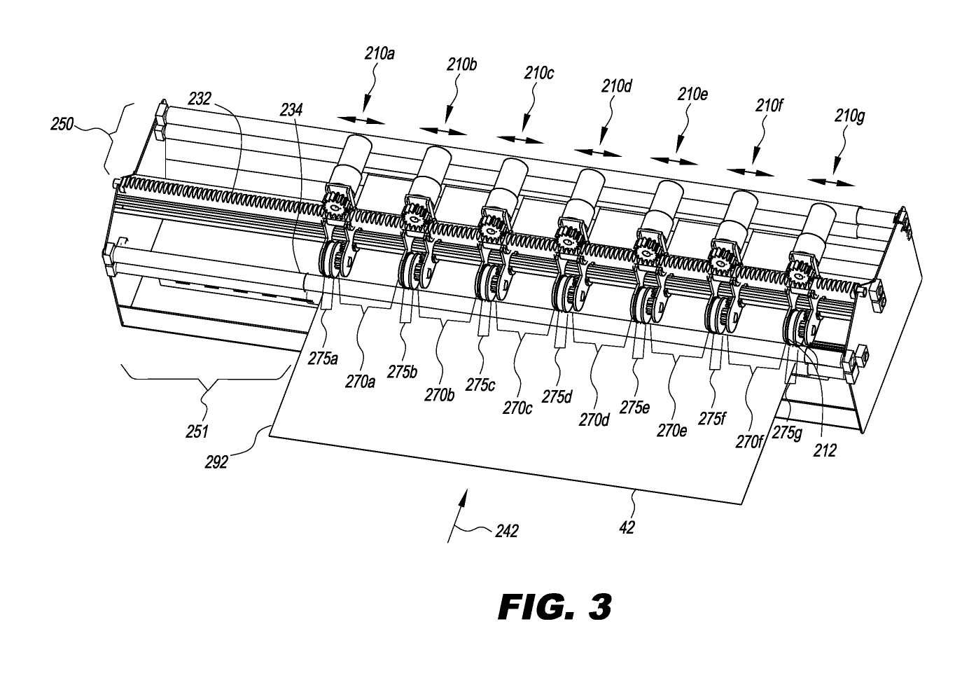

Transport mechanism 250 selectively translates the cutting devices 210, i.e. moves the cutting devices 210 perpendicular to feed direction 242 of receiver 42, to permit adjustment of the location and number of cuts. FIG. 3, discussed below, shows an example of 6-up cutting.

Controller 299 receives a job specification 261 including two or more specified cut locations and causes transport mechanism 250 to laterally position two or more of the cutting devices 210 to cut the moving receiver 42 in the specified cut locations. This is discussed further below with reference to

FIG. 4A. For 1-up cutting, non-chad area 270 is the printed page to be retained, and chad areas 275a, 275b are to be discarded.

In an aspect, drive mechanism 230 rotates the cutting wheels 212. Cutting devices 210, and specifically cutting wheels 212, are mounted on shaft 232, along which transport mechanism 250 selectively moves cutting wheels 212. Drive mechanism 230 drives shaft 232 to provide energy to rotate cutting wheels 212. Pressure wheel 214 is rotated by friction with the rotating cutting wheels 212. A non-chad area is defined between each adjacent pair of cutting wheels 212.

In another aspect, drive mechanism 230 rotates the pressure wheel 214. Pressure wheel 214 is mounted on shaft 234, along which transport mechanism 250 selectively moves pressure wheel 214. Drive mechanism 230 drives shaft 234 to provide energy to rotate pressure wheel 214. Cutting wheels 212 are rotated by friction with the rotating pressure wheel 214.

In yet another aspect, both cutting wheels 212 and pressure wheel 214 are mounted on driven shafts, and drive mechanism 230 drives both shafts.

In an aspect, drive mechanism 230 includes motor 231 for driving shaft 232 and motor 233 for driving shaft 234. Motors 231, 233 are controlled by controller 299, and can include encoders to report position back to controller 299. Stepper or servomotors can be used.

In various aspects, the driven shaft(s) 232, 234 extend beyond edge 292 of receiver 42 into area 251. Transport mechanism 250 is adapted to move at least one of the cutting devices 210 beyond the edge 292 of receiver 42. This permits adjustment of the number of cuts: for n-up printing, the number of cutting devices 210 positioned over receiver 42 is n+1. All cutting devices 210 not required for n-up cutting are positioned off receiver 42 in area 251.

FIG. 3 is an isometric view of a cutting apparatus according to various aspects. FIG. 3 shows the apparatus configured for 6-up cutting, in which receiver 42 is slit into six strips. This is useful e.g. for business-card printing, in which each strip is one business card wide. Cutting wheels 212, shaft 232, shaft 234, receiver 42, feed direction 242, transport mechanism 250, area 251, and edge 292 are as shown in FIG. 2. Each cutting device 210a-210g corresponds to cutting device 210 of FIG. 2.

In this aspect, all seven cutting devices, 210a-210g, are positioned over receiver 42. Cutting devices 210a and 210g are at the edges of receiver 42, to trim those edges and permit full-bleed output. Cutting devices 210b-210f are disposed over the internal area of receiver 42, i.e. receiver 42 extends perpendicular to feed direction 242 on both sides of each cutting device 210b-210f. Cutting devices 210a-210g define respective chad areas 275a-275g. Between the cutting devices are non-chad areas 270a-270f, which can be chopped (cut perpendicular to feed direction 242) to form business cards.

FIG. 4A is a front view of a cutting device according to various aspects. Receiver 42 is shown travelling in feed direction 242, into the plane of the image. Cutting device 210b, cutting wheels 212, pressure wheel 214, shaft 234, and shaft 232 are as shown in FIGS. 2 and 3. Non-chad areas 270a and 270b on each side of cutting wheels 212 are as shown in FIG. 3. Chad area 275b is as shown in FIG. 3. All cutting devices 210, 210a-210g are the same, so this figure is representative of cutting devices besides cutting device 210b.

Cutting wheels 212 are pressed laterally against pressure wheel 214. Therefore, as receiver 42 passes through cutting device 210b in feed direction 242, it is divided into three pieces: non-chad area 270a, chad area 275b, and non-chad area 270b.

In an aspect, the surface of pressure wheel 214 of each cutting device 210b is harder than the surface of the cutting wheels 212. This provides a self-sharpening action, in which contact with pressure wheel 214 while cutting sharpens cutting wheels 212. Hardness can be measured on a Shore A durometer or other hardness scales known in the art.

In another aspect, pressure wheel 214 of each cutting device 210b is harder than cutting wheels 212. For example, the bulk material of pressure wheel 214 can be harder throughout than the bulk material of cutting wheels 212. This also provides a self-sharpening action, in which contact with pressure wheel 214 while cutting sharpens cutting wheels 212.

In an aspect, friction member 410 is disposed between the cutting wheels 212 of one of the cutting devices 210b. Friction member 410 is adapted to draw receiver 42 through cutting device 210b. For example, friction member 410 and pressure wheel 214 of cutting device 210b can form a nip 414 through which the moving receiver 42 is drawn. In various aspects, friction member 410 is a compliant rotatable coaxial friction device such as a belt, roller, vacuum belt, or o-rings disposed between cutting wheels 212 for positively driving receiver 42 through cutting device 210.

Transport mechanism 250 includes rack 254 and pinion 252. Pinion 252 is driven by motor 253 to move cutting device 210 to a selected position with respect to receiver 42. Controller 299 (FIG. 2) provides power or drive commands to motor 253. Motor 253 can be a servomotor or stepper motor, and can include an encoder for position sensing and a transceiver for reporting position information to the controller 299. The terminals of the armature of motor 253 can be shorted to provide braking action to hold cutting device 210 in place while it is not being moved.

Referring back to FIG. 3, in an aspect, not all cutting devices have motors 253. In one example, cutting devices 210a and 210c have motors 253 and cutting device 210b does not. Cutting device 210b is moved to the right by pushing it with cutting device 210a and is moved to the left by pushing it with cutting device 210c. Similarly, cutting devices 210a, 201c, 210e, and 210g can have motors 253, and cutting devices 210b, 210d, and 210f can lack motors 253. Cutting devices without motors can include friction elements or clutches to hold them in position when they are not being pushed.

Still referring back to FIG. 3, in various aspects, cutting devices 210 positioned at the edges of receiver 42 (e.g. cutting devices 210a, 210g) can have only a single cutting wheel, or the outboard cutting wheels 212 of cutting devices 210a, 210g can be positioned off receiver 42. If both cutting wheels 212 of cutting devices 210, 210g are positioned over receiver 42, additional chad areas are cut outboard of chad areas 275a, 275g.

FIG. 4B is a side view of a cutting device according to various aspects. Cutting device 210b, cutting wheels 212, receiver 42, feed direction 242, shafts 232, 234, pressure wheel 214, rack 254, pinion 252, and motor 253 are as shown in FIG. 4A. Cutting wheels 212 turn with circumferential speed 4159, which is the magnitude of linear velocity at the outer circumference of the wheel. In an aspect, circumferential speed 4159 of cutting wheels 212 is at most 15% greater than the speed 442 (shown as the magnitude of the velocity vector of feed direction 242) of receiver 42 in feed direction 242. This advantageously provides positive take-up of receiver 42 and maintains tension with reduced risk of tearing receiver 42. In other aspects, circumferential speed 4159 is less than, equal to, or greater than the speed of receiver 42 in feed direction 242.

In an aspect, at least one of the cutting devices 210 includes deflector 460. Deflector 460 is laterally disposed in chad area 275b (FIG. 4A) of cutting device 210b and extends through the plane of receiver 42. Deflector 460 engages the chad as receiver 42 moves and directs the chad away from feed direction 242 of receiver 42. Receiver 42 can have folds, creases, and wrinkles, and still define a plane. The plane of receiver 42 can be defined as the best-fit plane of all possible vectors from one point of receiver 42 to another in the area of receiver 42 between cutting wheels 212 and pressure wheel 214.

In an aspect, chad chopper 465, represented graphically here as a pair of scissor blades, is disposed to receive the chad 404. Chad 404 is a continuous strip of material cut out of receiver 42. Chad chopper 465 chops chad 404 into chad pieces 405 for easier handling and disposal. Chad chopper 465 can be automatic scissors, a guillotine, an ulu, a laser, or another cutting device known in the art. Deflector 460 and chad chopper 465 advantageously separate chad-handling structures from non-chad-handling structures, permitting simplified structures for both.

Other aspects of transport mechanism 250 can be employed. Some are described herein; others will be obvious to those skilled in the art. The aspects below are not shown, but refer to parts on FIG. 2.

In an aspect, transport mechanism 250 includes a guide rod having a helical groove, and at least one carriage corresponding to one of the cutting devices 210. Each carriage includes a support that rides on the guide rod, two side walls attached to the support and adapted to retain the corresponding cutting device in lateral position with respect to the support, a pin for selectively mechanically engaging the support to the helical groove, so that the support translates along the length of the guide rod when the guide rod rotates, and an actuator responsive to the controller for causing the pin to engage.

In another aspect, transport mechanism 250 includes a magnetic-levitation (maglev) track along which cutting devices 210 move. Examples of maglev systems useful with various aspects include those described in U.S. Pat. No. 7,617,779, issued Nov. 17, 2009 to Studer, and U.S. Pat. No. 6,357,359, issued Mar. 19, 2002 to Davey et al., the disclosures of both of which are incorporated herein by reference.

In another aspect, transport mechanism 250 includes a cable, belt, or timing belt entrained around a drive pulley, and each cutting device 210 includes a grapple for selectively mechanically connecting the cutting device to the cable or belt. To move a cutting device 210, controller 299 causes cutting device 210 to engage its grapple and thereby connect itself to the cable or belt. The controller then activates a drive motor to rotate the drive pulley, and move each point of the cable around a loop. The cutting device that is connected to the cable or belt will move with the cable or belt. This is similar to the drive mechanism of a cable car or of an inkjet printer carriage.

In another aspect, transport mechanism 250 includes a ferromagnetic or other magnetic or ferrous cable or belt entrained around a drive pulley, and each cutting device 210 includes a magnetic grapple for selectively attracting the cable or belt. A grapple useful with various aspects is described in U.S. Pat. No. 5,525,950, issued Jun. 11, 1996 to Wang, the disclosure of which is incorporated herein by reference. To move a cutting device 210, controller 299 causes cutting device 210 to engage its grapple and thereby attach itself magnetically to the cable or belt. The controller then activates a drive motor to rotate the drive pulley, and move each point of the cable around a loop. The cutting device that is attached to the cable or belt will move with the cable or belt.

In another aspect, a telescoping pushrod with a key can be used to selectively engage a cutting device 210 and push or pull it. In another aspect, a rack and pinion can be employed, where the rack is an integral part of the rod supporting cutting devices 210 rather than a separate part.

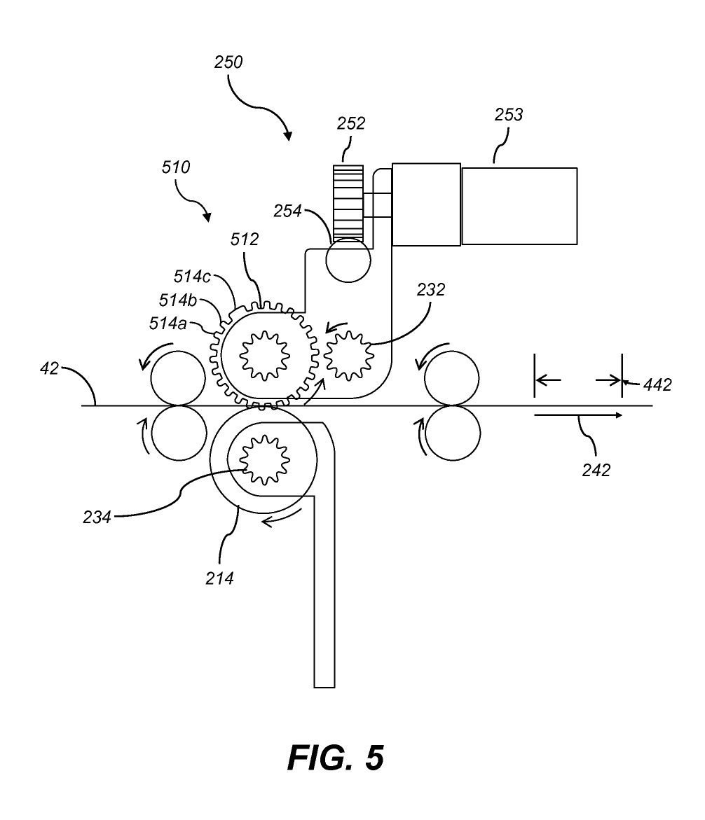

FIG. 5 is a side view of perforating device 510 for perforating moving receiver 42 according to various aspects. Receiver 42, feed direction 242, shafts 232 and 234 (represented graphically by the gears extending down their lengths), pressure wheel 214, rack 254, pinion 252, speed of the receiver 442, and motor 253 are as shown in FIG. 4A. Perforating wheels 512 turn with a selected circumferential speed. Throughout this disclosure, perforating wheels 512 can provide force to move receiver 42, or receiver 42 can be moved by other driving members, or any combination thereof.

Perforating wheels 512 are wheels that shear portions of receiver 42 against pressure wheel 214 to perforate receiver 42 according to the shape and size of the teeth. Specifically, two parallel perforating wheels 512 are pressed laterally against pressure wheel 214 to define two perforating areas and a chad area arranged laterally between the perforating areas. The spatial relationships between these components are as described above for cutting wheels 212, the cutting areas discussed above, and chad area 275b (FIG. 4A). The perforating areas are the (possibly long and narrow) areas of receiver 42 that receive the perforations.

In various aspects, friction member 410 (FIG. 4A) can be disposed between perforating wheels 512 of one of the plurality of perforating devices 510. Friction member 410 draws receiver 42 through the plurality of perforating devices 510, as discussed above with reference to cutting devices 210. Friction member 410 and pressure wheel 214 of the corresponding perforating device 510 can form a nip through which moving receiver 42 is drawn.

In various aspects, perforating wheels 512 are stepped or toothed. Specifically, perforating wheels 512 vary in radius around their circumferences, as shown, to form at least one protrusion 514a from each perforating wheel 512. The shape or size of protrusions 514a, 514b, 514c is selected to provide a desired shape or size of perforation. In some of these aspects, at least two protrusions 514a, 514b from the same perforating wheel 512 have the same tooth sizes, i.e., the same lengths along the circumference of perforating wheel 512. In some of these aspects, as shown here, the at least one protrusion includes two separated protrusions 514a, 514c from the same perforating wheel 512. Separated protrusions 514a, 514c have respective, different lengths along the circumference of the perforating wheel. In this example, protrusion 514a is a narrow tooth and protrusion 514c is a wide tooth.

In various aspects, a surface of pressure wheel 214 of each of the plurality of perforating devices 510 is harder than a respective surface of each of the corresponding perforating wheels 512, as discussed above.

Referring back to FIG. 2, a plurality of perforating devices can be arranged, e.g., as described above for cutting devices 210, into apparatus for perforating a moving receiver. The perforating apparatus is as shown in FIG. 2, but with perforating devices 510 in place of cutting devices 210. Drive mechanism 230 rotates perforating wheels 512 (FIG. 4B) or pressure wheel 214 of two or more of the plurality of perforating devices 510 so that the rotating perforating wheels 512 engage moving receiver 42 to perforate moving receiver 42 parallel to feed direction 242 in the perforating areas. As a result, one or more chads are defined, although not necessarily cut out immediately, on receiver 42.

Transport mechanism 250 selectively moves the plurality of perforating devices 510 (FIG. 5) perpendicular to feed direction 242 of receiver 42. This is as described above, but with perforating devices 510 moving instead of cutting devices 210. Perforating devices 510 can be mounted on a shaft 232 (FIG. 2) along which the transport mechanism can selectively move them, as described above with respect to cutting devices 210. As described above, transport mechanism 250 can include a guide rod having a helical groove; a maglev track; a cable, belt, or timing belt entrained around a drive pulley; a ferromagnetic or other magnetic or ferrous cable or belt entrained around a drive pulley; or a telescoping pushrod. Transport mechanism can also include corresponding components on perforating devices 510, as described above with reference to FIG. 4B for cutting devices 210. The drive mechanism can rotate the pressure wheels of two or more of the plurality of perforating devices, as described above, and the pressure wheels can be mounted on, and selectively moved along, shaft 234. Shafts 232 or 234 can extend beyond an edge of the receiver so that at least one of the perforating devices can be moved beyond the edge of the receiver, as described above with respect to cutting devices 210 (FIG. 2).

Controller 299 receives job specification 261 including two or more specified perforation locations. Job specification 261 is as described above, but with locations in which to perforate instead of locations in which to cut.

Controller 299 causes the transport mechanism to laterally position two or more of the plurality of perforating devices 510 (FIG. 5) to perforate moving receiver 42 in the specified perforation locations. After the perforations are made, they can be left as-is for secondary sheet processing, provided as-is to the end user, or sent to a downstream perforation-separating device which tears receiver 42 at the perforations.

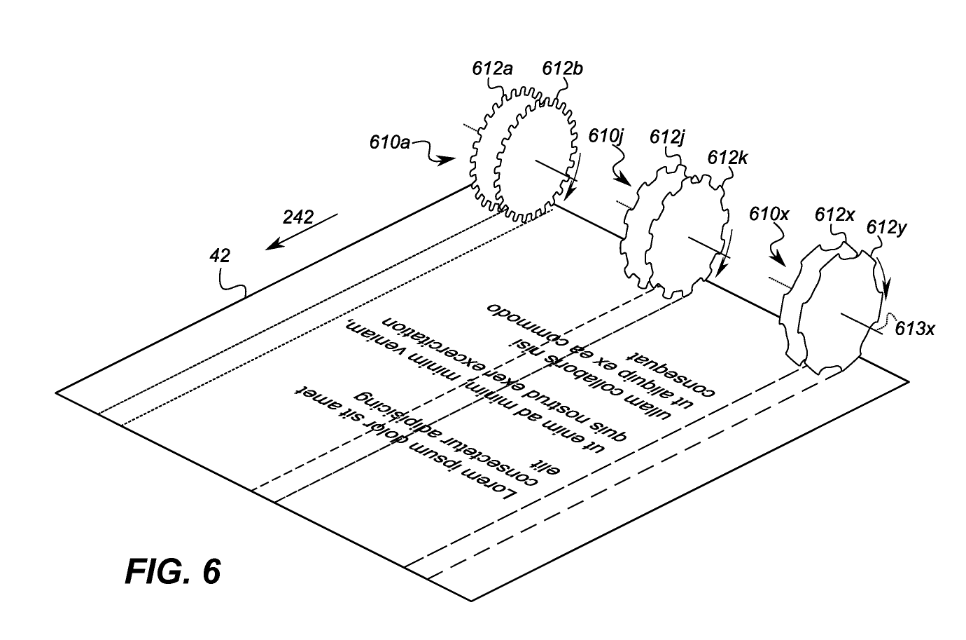

FIG. 6 shows receiver 42 being perforated by perforating devices 610a, 610j, 610x as receiver 42 moves in direction 242. The portion already perforated is visible to show the effects of different perforating wheels 612a, 612b, 612j, 612k, 612x, 612y. For clarity, only the perforating wheels and axis of rotation thereof (dotted line) of each perforating device are shown. Perforating device 610a has perforating wheels 612a, 612b, each of which varies in radius around its circumference to form 26 protrusions. Perforating device 610j has perforating wheels 612j, 612k, each of which likewise has 12 protrusions. Perforating device 610x has perforating wheels 612x, 612y, each of which likewise has 6 protrusions. Axis 613x of rotation of perforating wheels 612x, 612y is shown. Each perforating device 610a, 610j, 610x thus has a respective unique (in this printer) perforation length: short perforations from perforating device 610a, medium perforations from perforating device 610j, and large perforations from perforating device 610x.

Specifically, for any number of perforating devices, and the protrusions from the corresponding perforating wheels of each perforating device have respective lengths around their circumferences so that each perforating wheel forms perforations of the respective perforation length of the corresponding perforating device. A perforating apparatus can be loaded with different-perforation-length perforating wheels.

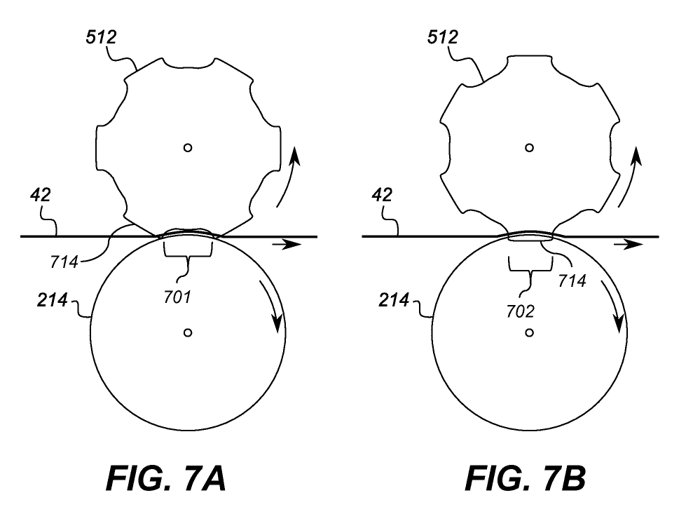

FIGS. 7A and 7B are side views of perforating wheel 512, pressure wheel 214, and receiver 42 according to various aspects. In FIG. 7A, protrusion 714 is not pressing into receiver 42, so region 701 is not slit. In FIG. 7B, protrusion 714 is pressing into receiver 42, so region 702 is slit. This alternation of slit and unslit regions is the perforation pattern in this example.

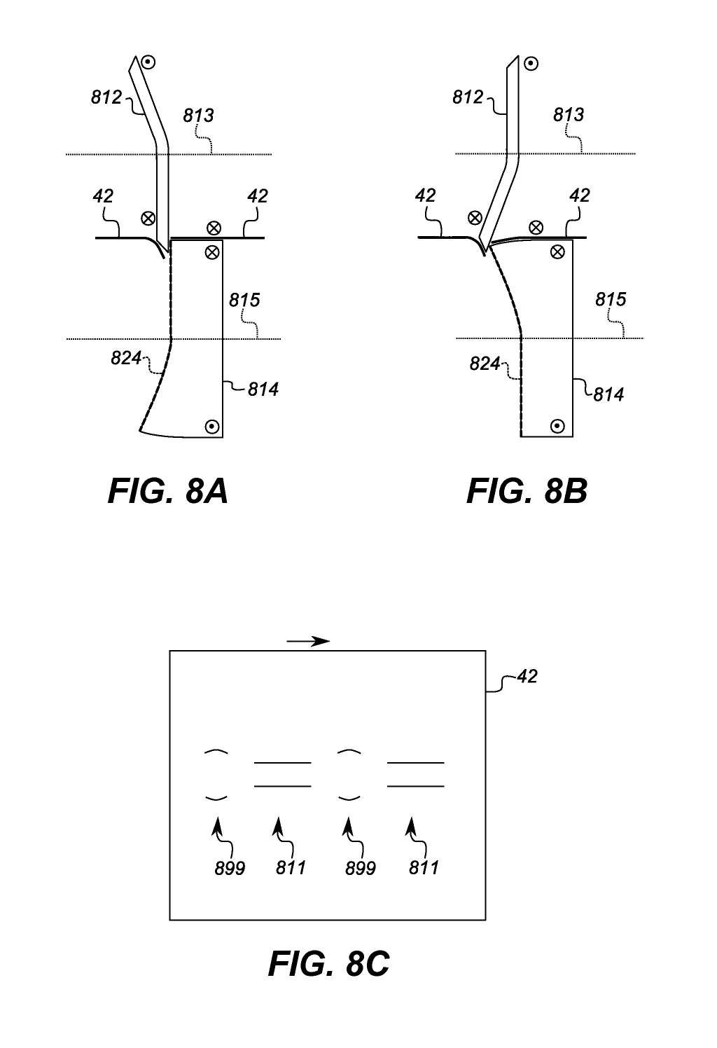

FIGS. 8A and 8B are front views of portions of a puncturing device according to various aspects. The aspects shown in these figures refer to cutting devices having wheels without protrusions and to perforating devices having wheels with protrusions. These two types of wheels are referred to collectively as “puncturing wheels,” e.g., puncturing wheel 812, and the two types of devices are referred to collectively as “puncturing devices.” For clarity, no visual distinction is made between protrusions and non-protruding areas in these figures, since puncturing wheel 812 can have protrusions (perforate) or not (cut). Also for clarity, only one puncturing wheel 812 is shown, even though a puncturing device can have two puncturing wheels 812, e.g., as shown on FIGS. 4A and 6.

Puncturing wheel 812 is pressed laterally against pressure wheel 814, e.g., as described above with reference to FIG. 4A. Receiver 42, shown here moving into the plane of the figure, is cut (slit, chopped, perforated) by the shear of puncturing wheel 812 against pressure wheel 814. As shown, puncturing wheel 812 (e.g., a perforating wheel) is non-planar. Referring to FIG. 8A, above axis 813, puncturing wheel 812 does not extend normal to axis 813, unlike below axis 813. Pressure wheel 814 includes non-planar mating surface 824 corresponding to perforating wheel 812. Surface 824 is indicated graphically by a heavy dashed line. Above axis 815, surface 824 extends normal to axis 815. Below axis 815, surface 824 extends off-normal in a way corresponding to the extension of puncturing wheel 812 above axis 813. In various aspects, puncturing wheel 812, pressure wheel 814, and surface 824 are shaped as one or more involute curves, e.g., gear teeth.

FIG. 8B shows puncturing wheel 812 on axis 813, pressure wheel 814 on axis 815, and receiver 42 as shown in FIG. 8A. However, in FIG. 8B, puncturing wheel 812 and pressure wheel 814 have rotated 180° compared to their position in FIG. 8A. The result is that the lateral position of the perforations changes.

FIG. 8C shows a hypothetical example of puncturing, specifically perforating, using non-planar puncturing wheels 812 and mating surfaces 824 (both FIG. 8B). Receiver 42 has been punctured to form straight perforations 811.

These are made by the portions of puncturing wheel 812 and mating surface 824 extending normal to axes 813, 815 respectively (both axes FIG. 8B). Receiver 42 has also been punctured to form curved perforations 899. These are made by the portions of puncturing wheel 812 and mating surface 824 not extending normal to axes 813, 815 respectively (both axes FIG. 8A). The sizes and shapes of puncturing wheel 812 and mating surface 824 can be selected to provide desired puncturing effects, e.g., pinking or other decorative edging, wavy tear-off perforated lines, or perforated lines that only extend part way across a receiver (e.g., using a puncturing wheel 812 with a circumference greater than the extent of receiver 42 in the direction puncturing wheel 812 punctures).

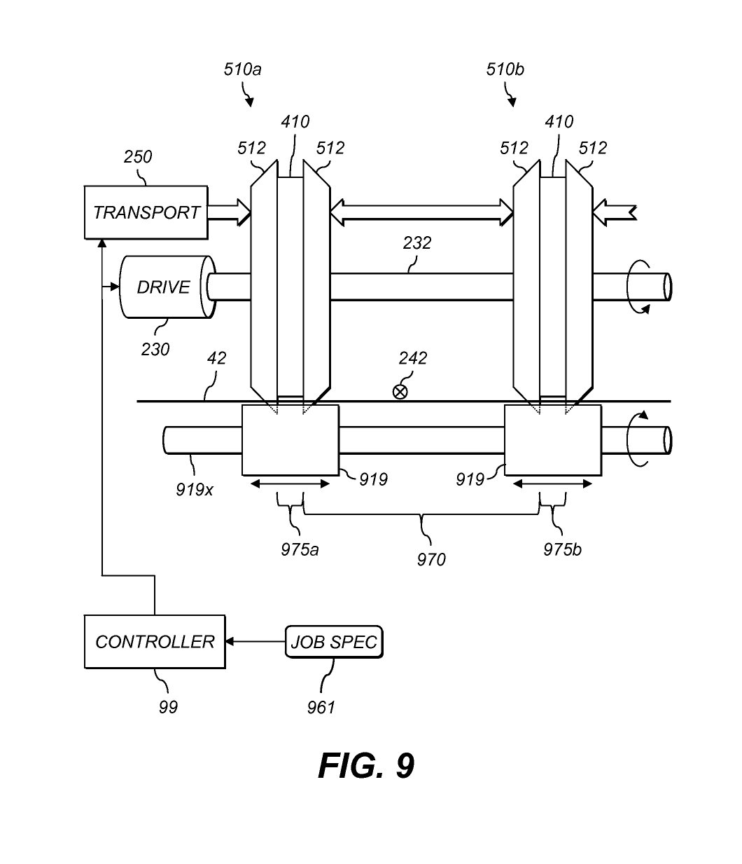

FIG. 9 is a front elevation of apparatus for perforating a moving receiver according to various aspects. Each of a plurality of perforating devices 510a, 510b includes two parallel perforating wheels 512 and backer member 919. Backer member 919 is at least partly compliant or yielding. In various aspects, backer members 919 rotate around a rotational axis of shaft 919x. At least part of each perforating wheel 512 is pressed towards backer member 919 to define, for each perforating device 510a, 510b, two respective perforating areas and a respective chad area 975a, 975b arranged laterally between the respective perforating areas. Non-chad area 970 is laterally between chad areas 975a, 975b in this example. Chad areas 975a, 975b and non-chad area 970 are defined by the travel of perforating wheels 512 as chad area 275b and non-chad areas 270a, 270b are defined by the travel of cutting wheels 212 (all FIG. 4A).

In various aspects, backer members 919 rotate so they have the same circumferential velocity as perforating wheels 512. Backer members 919 can be belts entrained around pulleys or drums upstream and downstream of perforating wheels 512. Backer shoes behind belt backer members 919 can provide a desired normal force between perforating wheels 512 and belt backer members 919. Backer members 919 can also be compliant drums, e.g., silicone-rubber cylinders, as shown.

Drive mechanism 230 rotates perforating wheels 512 or backer member 919 of two or more of the plurality of perforating devices 510a, 510b so that the rotating perforating wheels 512 engage the moving receiver 42 (moving into the plane of the page in this example). This results in perforating moving receiver 42 parallel to its feed direction 242 in the perforating areas. As a result, one or more chads are defined on receiver 42. If the perforations do not completely separate the chad from receiver 42, the chad is defined but not removed. Various aspects of drive mechanism 230 described above can be used.

Transport mechanism 250, represented graphically by block arrows, selectively moves perforating devices 510a, 510b perpendicular to feed direction 242 of receiver 42. Various aspects of transport mechanism 250 described above can be used.

Controller 99 receives job specification 961 including two or more specified perforation locations. Controller 99 causes transport mechanism 250 to laterally position two or more of the perforating devices 510a, 510b to perforate moving receiver 42 in the specified perforation locations. Controller 99 can also perform this function with respect to perforating device 510 shown in FIG. 5.

In various aspects, perforating wheels 512 vary in radius around their circumferences to form at least one protrusion from each perforating wheel, as discussed above with reference to FIG. 5. Also as discussed in FIG. 5, two separated protrusions with different lengths can be used; each perforating device 510a, 510b can have a respective unique perforation length; or perforating wheels 512 can be non-planar. As discussed above, drive mechanism 230 can rotate perforating wheels 512, which are moveable on shaft 232, which can extend beyond an edge of receiver 42. In other aspects, drive mechanism 230 rotates backer members 919 of two or more of the plurality of perforating devices 510a, 510b. Backer members 919 are mounted on shaft 919x, along which transport mechanism 250 selectively moves backer members 919. Shaft 919x can extend beyond an edge of receiver 42. Transport mechanism 250 can move at least one of the plurality of perforating devices 510a, 510b beyond the edge of receiver 42.

In various aspects, friction member 410 is disposed between perforating wheels 512 of one of the plurality of perforating devices 510a, 510b. Friction member 410 draws receiver 42 through the plurality of perforating devices. In various aspects, friction member 410 and backer member 919 of the corresponding perforating device 510a, 510b form a nip (for clarity, not labeled) through which moving receiver 42 is drawn.

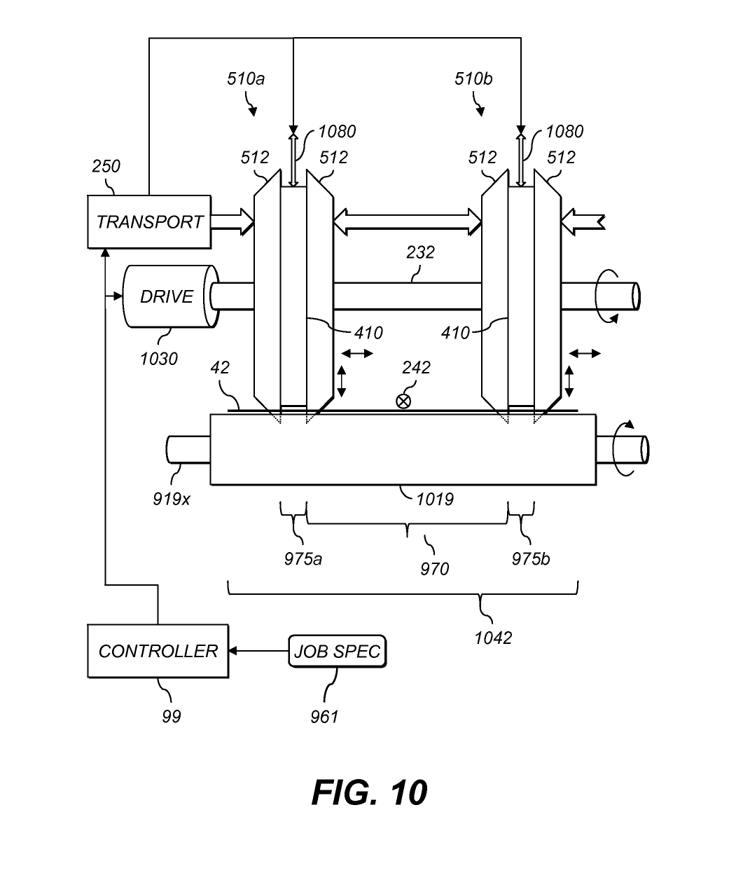

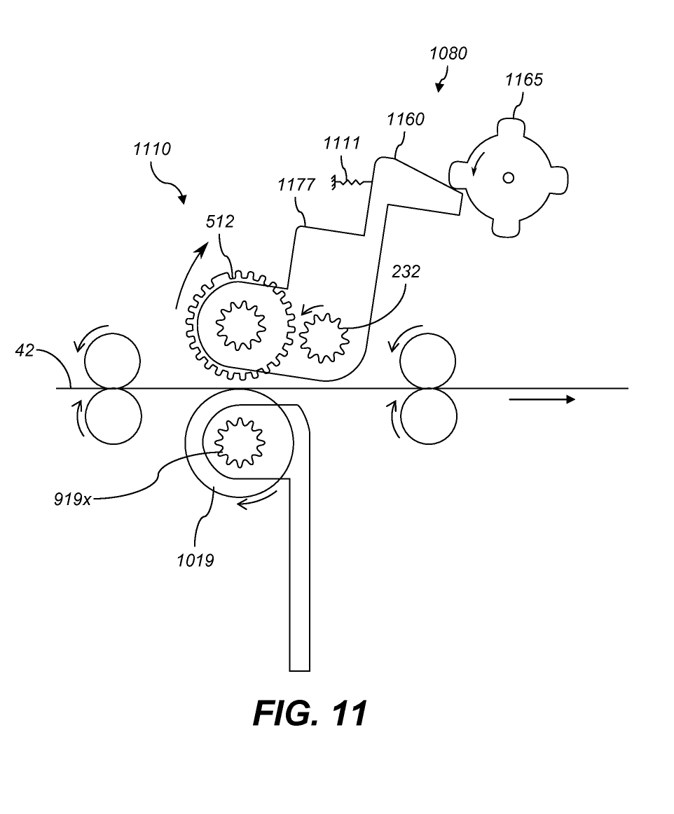

FIG. 10 is a front elevation of apparatus for perforating a moving receiver according to various aspects. Backer member 1019, e.g., a rubber drum, extends across width 1042 of a sheet area over which receiver 42 passes. Each perforating device 510a, 510b includes two parallel perforating wheels 512 and engagement device 1080 (described below with reference to FIG. 11; represented graphically here by open arrows). The engagement device is adapted to selectively press perforating wheels 512 towards backer member 1019 in a first condition to define two perforating areas and a chad area 975a, 975b arranged laterally between the perforating areas, or to selectively retract perforating wheels 512 from backer member 1019 in a second condition. In various aspects, backer member 1019 has a compliant surface, i.e., is formed from a compliant material or includes a coating of a compliant material around a compliant or non-compliant support member.

Drive mechanism 1030 rotates backer member 1019 or perforating wheels 512 of two or more of the plurality of perforating devices 510a, 510b so that the rotating perforating wheels 512 engage moving receiver 42 to perforate moving receiver 42 parallel to its feed direction 242 in the perforating areas. This defines (but does not necessarily cut out, as discussed above) one or more proto-chads on receiver 42. Tearing along the perforations or otherwise separating the proto-chad from receiver 42 turns the proto-chad into a chad.

Transport mechanism 250, as discussed above, selectively moves the plurality of perforating devices 510a, 510b perpendicular to feed direction 242 of receiver 42. Transport mechanism 250 can also control the respective engagement devices 1080 of perforating devices 510a, 510b, or controller 99 can control the engagement devices 1080 directly.

Controller 99 receives job specification 961 including two or more specified perforation locations. Controller 99 causes transport mechanism 250 to operate engagement devices 1080 of a selected two or more of the perforating devices 510a, 510b in the second condition (perforating wheels 512 retracted). Controller 99 then causes transport mechanism 250 to laterally position the selected perforating devices 510a, 510b to perforate moving receiver 42 in the specified perforation locations from job specification 961. Controller 99 then causes transport mechanism 250 to operate engagement devices 1080 of the selected perforating devices 510a, 510b in the first condition (engaged) so that receiver 42 will be perforated while it moves.

In various aspects, drive mechanism 1030 rotates perforating wheels 512. Perforating wheels 512 are mounted on shaft 232, along which transport mechanism 250 selectively moves perforating wheels 512. Shaft 232 can extend beyond the edge of the receiver and transport mechanism 250 can move at least one of the perforating devices 510a, 510b beyond the edge of receiver 42. In other aspects, drive mechanism 1030 rotates backer member 1019, e.g., by rotating shaft 919x on which backer member 1019 is located.

In various aspects, friction member 410 is disposed between perforating wheels 512 of one of the plurality of perforating devices 510a, 510b. Friction member 410 draws receiver 42 through the plurality of perforating devices 510a, 510b. In various aspects, friction member 410 and backer member 1019 form a nip (not shown) through which moving receiver 42 is drawn. In various of these aspects, friction member 410 and backer member 1019 have compliant surfaces (“compliant surface” is defined above).

FIG. 11 is a side elevation of the apparatus of FIG. 10 according to various aspects. Perforating device 1110 has perforating wheel 512, which can be driven by shaft 232. Receiver 42, backer member 1019, and shaft 919x are as shown in FIG. 10. In these aspects, engagement device 1080 includes lever 1160. Cam wheel 1165 rotates, and when one of the protrusions therefrom engages lever 1160, the bracket 1177 holding perforating wheel 512 rotates around shaft 232. This retracts perforating wheel 512 from backer member 1019. When a protrusion of cam wheel 1165 is not engaged with lever 1160, spring 1111 presses perforating wheels 512 towards backer member 1019. This defines two perforating areas and a chad area arranged laterally between the perforating areas. Further details of engagement devices 1080 are given in U.S. Publication No. 2011/0293351 by Kwarta et al., the disclosure of which is incorporated herein by reference. The engagement device 1080 can also include a solenoid, air cylinder, or rotating motor to which a bracket holding perforating wheel 512 is attached. The engagement device 1080 can also include an electromagnetic pickup coil that selectively attracts such a bracket, and optionally a spring working against the electromagnet to return perforating wheel 512 to a desired position when the electromagnet is off.

In various aspects, the force applied by the engagement device 1080 to press perforating wheel 512 towards receiver 42 is selected based on a media type of receiver 42. For example, a lower force can be used for newsprint than for cardstock.

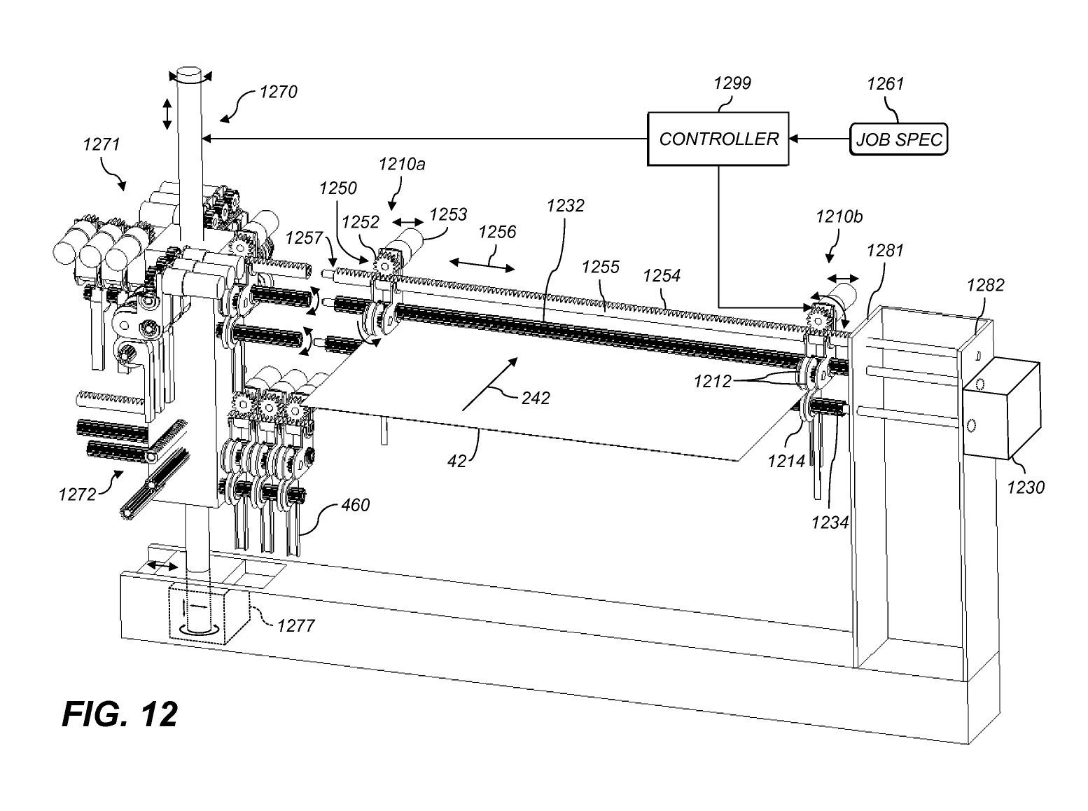

FIG. 12 is an axonometric view of apparatus for selectively puncturing a moving receiver according to various aspects. As discussed above, “puncturing” can be cutting or perforating. “Puncturing” as used herein can also include scoring the receiver, even if the scoring does not open a void or slit all the way through the receiver. For clarity, motion arrows are not shown on each component of a given type, but only on a subset thereof (e.g., only on some puncturing wheels 1212.

Each of a plurality of puncturing devices 1210a, 1210b includes two parallel puncturing wheels 1212 and pressure wheel 1214. Puncturing wheels 1212 and pressure wheel 1214 are arranged so that force (e.g., to shear receiver 42 to cut it) can be applied between puncturing wheels 1212 and pressure wheel 1214 to puncture moving receiver 42. Two puncturing areas and a chad area arranged laterally between the puncturing areas are thus defined. (In other aspects, only one cutting wheel is used per cutting device.)

Drive mechanism 1230 rotates puncturing wheels 1212 or pressure wheel 1214 of two or more of the plurality of puncturing devices 1210a, 1210b. As a result, the rotating puncturing wheels 1212 engage moving receiver 42 to puncture moving receiver 42 parallel to feed direction 242 in the puncturing areas. This defines one or more shads on receiver 42. Since puncturing can include cutting, perforating or scoring, the chad is not necessarily cut out or physically separated from the remainder of receiver 42. Deflector 460, when used (e.g., with cutting devices), is as shown in FIG. 4B.

Transport mechanism 1250 selectively moves puncturing devices 1210a, 1210b across, e.g., perpendicular to or at a 45° angle to, feed direction 242 of receiver 42. Details of transport mechanism 1250 are discussed below; aspects described above can also be used.

Controller 1299 receives job specification 1261 including two or more specified puncture locations. Controller 1299, which can include components described above for controller 99, causes transport mechanism 1250 to laterally position two or more of the plurality of puncturing devices 1210a, 1210b to puncture moving receiver 42 in the specified puncture locations. For clarity, not all connections between controller 1299 and components of transport mechanism 1250 or other components are shown.

In various aspects, at least one of the puncturing devices 1210a, 1210b is a cutting device with puncturing wheels 1212 pressed laterally against pressure wheel 1214, e.g., as discussed above with reference to FIGS. 4A and 413. At least one of the puncturing devices 1210a, 1210b is a perforating device with puncturing wheels 1212 pressing into pressure wheel 1214, e.g., as discussed above with reference to FIG. 9. In these aspects, pressure wheel 1214 of the perforating device can have a compliant surface, as described above.

In various aspects, at least two of the puncturing devices 1210a, 1210b are cutting devices (e.g., FIGS. 4A, 4B) with respective puncturing wheels 1212 pressed laterally against respective pressure wheels 1214. Puncturing devices 1210a, 1210b differs from each other in engagement force (pressing down into receiver 42), engagement depth (into receiver 42), blade width (width of the cutting surface of puncturing wheels 1212), or blade material (composition of the cutting surface of puncturing wheels 1212).

As discussed above, in various aspects, transport mechanism 1250 transports puncturing devices 1210a, 1210b, which can be perforating devices, along shaft 1255 extending along transport axis 1256. In some of these aspects, shaft 1255 includes rack 1254 and transport mechanism 1250 includes per-puncturing-device pinion 1252 engaged with rack 1254. Pinion 1252 is driven by per-puncturing-device motor 1253 to move the respective puncturing device (e.g., 1210a, 1210b to a selected position with respect to receiver 42. Controller 1299 provides power or drive commands to motor 1253. Motor 1253 can be a servomotor or stepper motor, and can include an encoder for position sensing and a transceiver for reporting position information to the controller. The terminals of the armature of motor 1253 can be shorted to provide braking action to hold the respective puncturing device (e.g., 1210a or 1210b) in place while it is not being moved. Other aspects include a smooth shaft (instead of rack 1254) and an encoder on each puncturing device 1210a, 1210b to determine the position thereof, as discussed above.

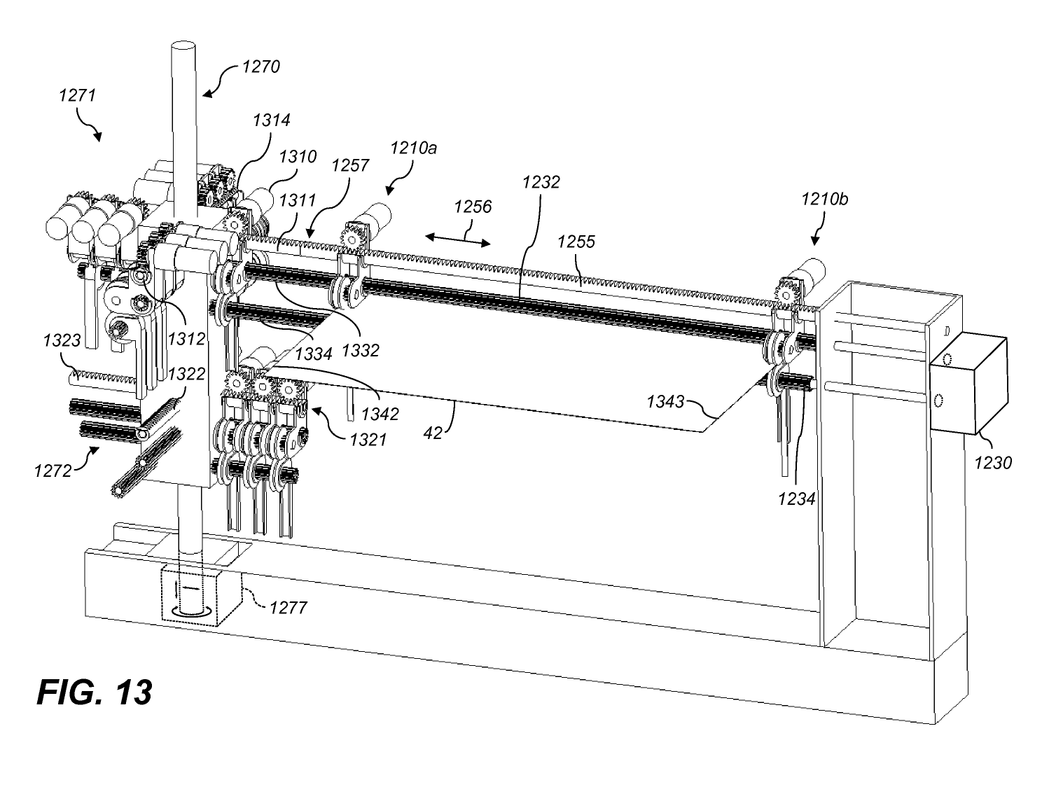

In various aspects, rotatable turret 1270 is arranged along transport axis 1256 at end 1257 of shaft 1255. Shaft 1255 can be cantilevered opposite from end 1257, as shown, or supported or mounted in other ways. In various aspects, shafts 1255, 1232, 1234 are supported by mounting bearings or other features in supports 1281, 1282 that are spaced apart. In this example, supports 1281, 1282 are plates. This provides increased support, reducing the droop of shafts 1255, 1232, 1234 near end 1257. In various aspects, the features in support 1281 are designed to fit loosely so that the shafts will not be overconstrained when turret 1270 is engaged. Turret 1270 includes a first plurality of shaft segments 1271, discussed below with respect to FIG. 13. Turret 1270 also includes actuator 1277, e.g., a motor as described herein. Actuator 1277 selectively aligns one of the shaft segments 1271 with shaft 1255. This permits moving one or more puncturing devices 1210a, 1210b between that shaft segment and shaft 1255. The shafts can move up and down, rotate, or any combination thereof. Since puncturing devices can be moved between various shaft segments 1271, various puncturing devices (e.g., puncturing devices 1210a, 1210b) can be stored on shaft segments 1271 and used as desired. Different puncturing devices can be used for different media characteristics. For example, a different cutting-blade geometry can be used for paper at most 15 pt. thick than for paper more than 15 pt. thick. Multiple substantially identical puncturing devices can also be stored and used as hot-spares for each other to reduce apparatus downtime when a particular puncturing device needs service or maintenance. The puncturing device needing maintenance can be moved onto turret 1270 and a replacement unit moved off turret 1270. This can permit removing the puncturing device needing maintenance from one of the shaft segments 1271 without interrupting the operation of the puncturing apparatus. In various aspects, support arms (not shown) move or telescopically extend to support the ends of shafts 1255, 1232, 1234 while turret 1270 is disengaged, as shown. The support arms move or retract away from shafts 1255, 1232, 1234 when turret 1270 is engaged. The arms engage with shafts 1255, 1232, 1234 a distance away from turret 1270 selected so that there is room on shafts 1255, 1232, 1234 for puncturing devices 1210a, 1210b to move on and off shafts 1255, 1232, 1234. For example, a support arm can support shaft 1255 10 cm from end 1257. In various aspects, the support arms are mounted on turret 1270. In various aspects, rotatable turret 1270 further includes a second plurality of shaft segments 1272. Actuator 1277 can translate turret 1270 normal to shaft 1255. This permits aligning with shaft 1255 either a shaft segment of shaft segments 1271, or a shaft segment of shaft segments 1272.

In various aspects, turret 1270 translates in a direction along transport axis 1256 to selectively engage an aligned one of the shaft segments 1271, 1272 with shaft 1255. In the example shown, shaft 1255 has a protrusion at end 1257 and shaft segments 1271, 1272 have mating recesses that can engage with the protrusion when turret 1270 translates. In other aspects, turret 1270 is stationary and shaft 1255 translates.

FIG. 13 is an axonometric view of portions of the apparatus of FIG. 12 according to various aspects, shown with shaft 1255 and shaft segment 1311 of turret 1270 engaged. End 1257, transport axis 1256, actuator 1277, drive mechanism 1230, and shafts 1232, 1234 are as shown in FIG. 12. In various aspects, when shaft segment 1311 engages with shaft 1255, corresponding shaft segments 1332, 1334 engage with shafts 1232, 1234, respectively. Interfaces between shaft segments 1311, 1332, 1334 and shafts 1255, 1232, 1234 can include keys, keyways, latches, or other mechanical features to transfer force or torque between shaft segments 1311, 1332, 1334 and shafts 1255, 1232, 1234.

In this example, shaft segments 1271 include shaft segment 1311, shaft segment 1312, shaft segment 1314, and one other (not labeled). Shaft segments 1272 include shaft segment 1321, shaft segment 1322, shaft segment 1323, and one other (not visible). Turret 1270 can include any number of shaft segments per group, and can undergo any motion in six degrees of freedom to align a desired shaft segment with shaft 1255. As shown, shaft segment 1311 is holding puncturing device 1310. Puncturing devices 1210a, 1210b have been moved off shaft segment 1311 by transport mechanism 1250 (FIG. 12) onto shaft 1255.

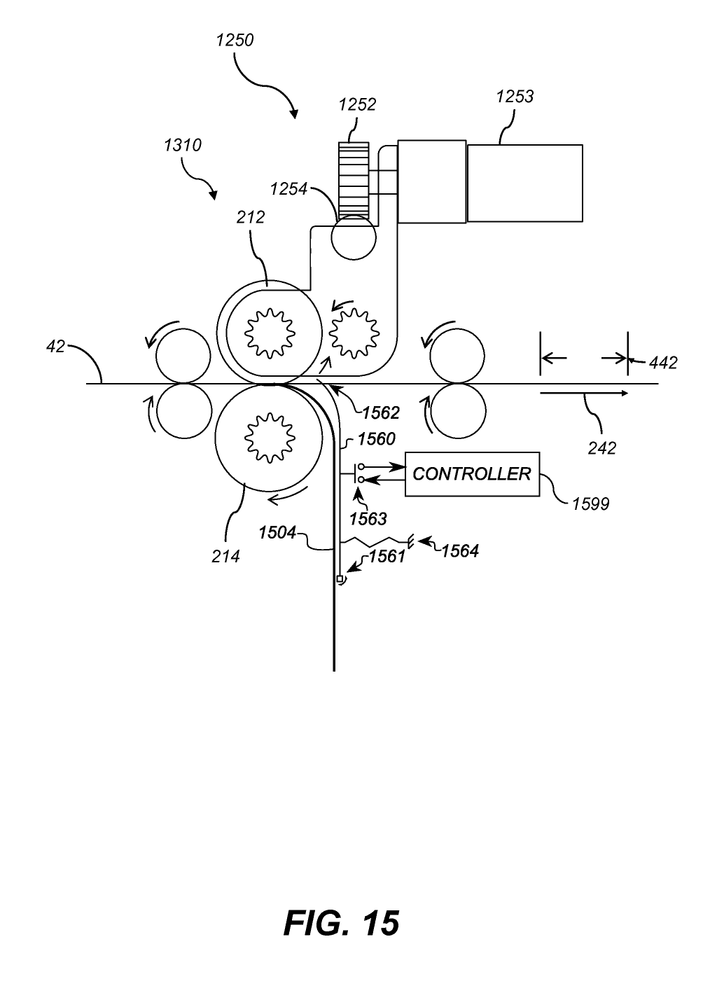

In various aspects, two of the puncturing devices are first and second interchangeable puncturing devices 1210a, 1310. “Interchangeable” puncturing devices 1210a, 1310 are two or more puncturing devices that can perform a single specified function within a single specified set of tolerances. For example, two cutting devices with the same width of the chad area can be interchangeable. Two perforating devices with the same protrusion configuration (within tolerances) can also be interchangeable. A sensor (described below with reference to FIG. 15) detects that puncturing device 1210a requires service or maintenance, e.g., because a puncturing wheel 1212 (FIG. 12) thereof has become dull. Controller 1299 (FIG. 12) is responsive to the sensor to operate transport mechanism 1250 (FIG. 12) and turret 1270. Controller 1299 causes puncturing device 1210a to be moved off shaft 1255 onto a shaft segment, e.g., shaft segment 1322, which has room to hold puncturing device 1210a. Second puncturing device 1310 is moved off shaft segment 1311 onto shaft 1255, where it can take the place of the dulled puncturing device 1210a.

In various aspects, shaft 1255 extends beyond first edge 1342 of receiver 42. Transport mechanism 1250 (FIG. 12) is adapted to move at least one of the puncturing devices 1210a, 1210b, 1310 beyond first edge 1342 of receiver 42. In the example shown, transport mechanism 1250 can move puncturing device 1210a slightly to the left past first edge 1342 but not yet on shaft segment 1311. In various aspects, shaft 1255 further extends beyond second edge 1343 of receiver 42. Transport mechanism 1250 is adapted to move at least one of the puncturing devices 1210a, 1210b, 1310 beyond second edge 1343 of receiver 42. In the example shown, puncturing device 1210b can be moved slightly to the right on shaft 1255. Shafts extending beyond edges of receiver 42 are as described above with respect to cutting devices 210 (FIG. 2).

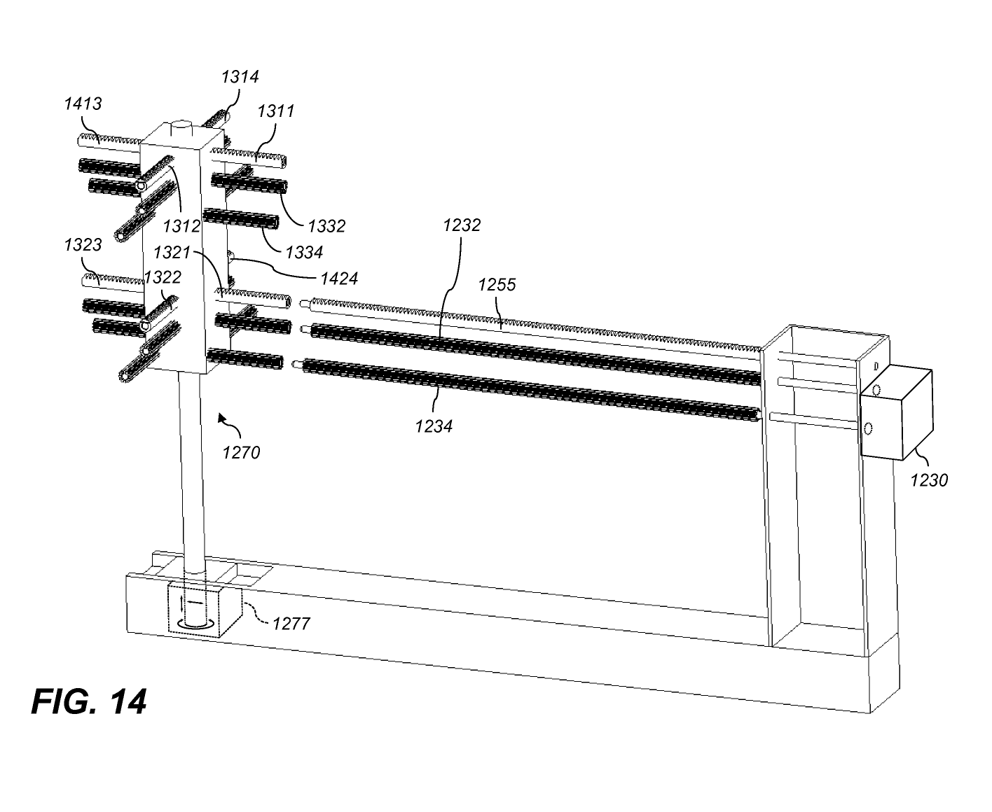

FIG. 14 is an axonometric view of portions of the apparatus of FIG. 12 according to various aspects. FIG. 14 shows turret 1270 translated to align shaft segment 1321 with shaft 1255. Actuator 1277, drive mechanism 1230, shaft segments 1332, 1334, and shafts 1232, 1234, and 1255 are as shown in FIG. 12, as are shaft segments 1311, 1312, 1314, 1322, and 1323. Shaft segments 1413 and 1424 are visible in FIG. 14; they were obscured in FIG. 13.

FIG. 15 shows puncturing device 1310 with a sensor according to various aspects. Puncturing device 1310 is a cutting device having cutting wheel 212 and pressure wheel 214. Transport mechanism 1250, pinion 1252, motor 1253, rack 1254, receiver 42, and feed direction 242 are as shown in FIG. 12. Deflector 1560 is a sensor arranged downstream of the cutting device (puncturing device 1310) and outside the plane of moving receiver 42 (as drawn, a horizontal plane into and out of the figure, intersecting receiver 42). The sensor detects chad 1504, so that when chad 1504 is not detected, puncturing device 1310 needs service. For example, when cutting wheels 212 no longer cut chad 1504 out of receiver 42, cutting wheels 212 need sharpening or replacement. Various types of sensors can be used, including optointerruptors, pressure or flow sensors detecting changes in an airflow directed where chad 1504 should be, or where it should not be, or mechanical sensors.

In various aspects, the sensor includes chad deflector 1560 mounted at fixed end 1561. Deflector 1560 has free end 1562 protruding into the chad area. Switch 1563 is adapted to detect bending of chad deflector 1560, or rotation of chad deflector 1560 substantially about fixed end 1561. When chad deflector 1560 bends or rotates, chad 1504 is detected. Deflector 1560 can be made from a flexible material, e.g., Mylar, or can be mounted to pivot and be spring-loaded.

In the example shown, spring 1564 is extended and resists contraction, and switch 1563 is normally open. In normal use, chad 1504 will be deflected downward by deflector 1560, but will exert relatively little force on deflector 1560 since the material of chad 1504 is readily bendable out of the plane of receiver 42. When chad 1504 is not completely cut from receiver 42, however, chad 1504 and attached portions of receiver 42 will exert relatively more force on deflector 1560, closing switch 1563. Switch 1563 is connected to controller 1299 (FIG. 12) so that when switch 1563 closes, controller 1599 can determine that a chad is not detected, and thus that puncturing device 1310 needs service.

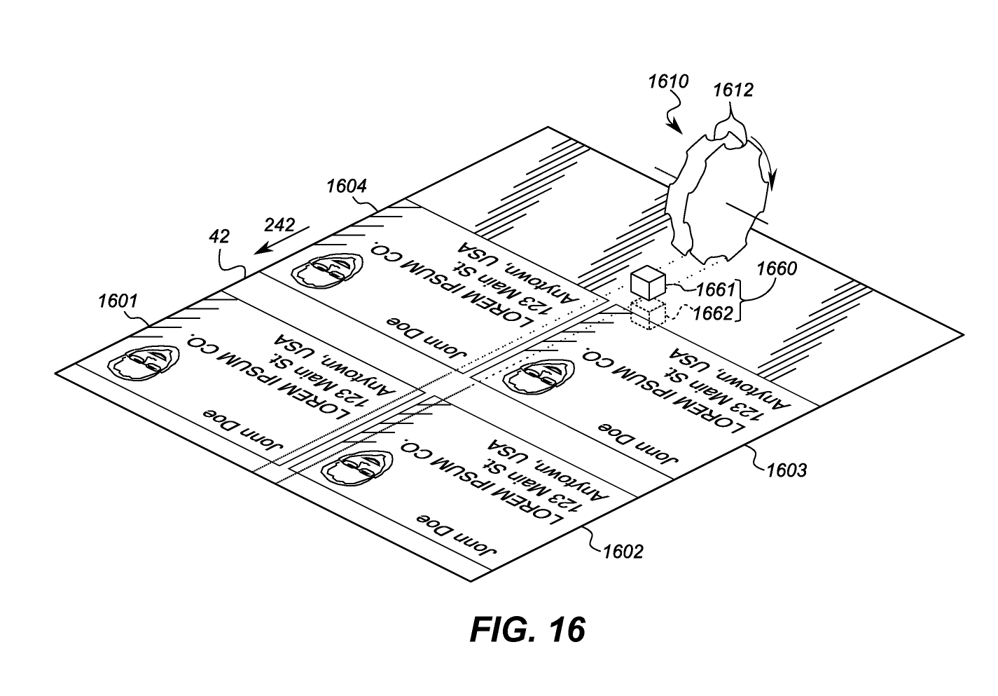

FIG. 16 shows receiver 42 being perforated by perforating device 1610 as receiver 42 moves in direction 242. In this example, receiver 42 has been printed with full-bleed business cards that should be torn apart after perforating. This figure, and the perforations, are not to scale. Perforating device 1610 is a puncturing device. Detector 1660 is adapted to detect dull perforations produced by perforating device 1610, so that when dull perforations are detected above a selected threshold, controller 1299 (FIG. 12) determines that perforating device 1610 requires service. In this example, business-card areas 1601 and 1602 were perforated correctly, indicated graphically by the closely-spaced dots (closely-spaced punctures in receiver 42). However, perforating wheels 1612 became dull. As a result, business-card areas 1603 and 1604 were not perforated correctly, indicated graphically by the increasing spacing between dots (more widely-spaced punctures, so less effective perforation). Detector 1660 detects the incorrect perforating of receiver 42 in the business-card areas 1603 and 1604, or downstream thereof, and in response controller 1299 (FIG. 12), which is connected to detector 1660, determines perforating device 1610 requires service.

In various aspects, detector 1660 includes optical source 1661 and optical detector 1662 arranged on opposite sides of receiver 42. In FIG. 16, optical source 1661 is above receiver 42 and optical detector 1662 is below receiver 42. Optical source 1661 can be a lightbulb, LED, laser, or other source of coherent or incoherent optical radiation at a wavelength that will interact with receiver 42 and the perforations therein. It is not required that wavelength be visible to the unaided human eye. Optical detector 1662 is a detector, e.g., an area-scan CCD or CMOS image sensor or a piece of film, responsive to the wavelength of radiation from optical source 1661. Optical source 1661 and optical detector 1662 are placed so that the perforation areas (in this example, the lines of dots indicating perforations) lie in the field of view of both.

In various aspects, optical source 1661 illuminates an area of receiver 42 through which perforations should pass. Optical detector 1662 detects bright spots at holes in receiver 42 where light passes through. In other aspects, optical source 1661 illuminates an area of receiver 42 with coherent illumination (e.g., laser light, optionally spread into a wide beam). Optical detector 1662 detects diffraction patterns of the light through the perforations.

In various aspects, detector 1660 counts pages perforated, and perforating device 1610 requires service after a selected number of pages have been perforated. In various aspects, perforating device 1610 is periodically removed from service and used to perforate a test page, which is then inspected visually or automatically to determine whether one or more perforating wheels 1612 requires service.

In various aspects, detector 1660 includes a pressure source and a pressure sensor on opposite sides of receiver 42. The pressure source produces a gas jet (e.g., an air jet) that impinges receiver 42. If a perforation is present under the air jet, the pressure sensor will sense an increase in air pressure from the air of the jet passing through the perforation.

In various aspects described throughout this disclosure, perforating device 1610 does not punch all the way through receiver 42, but instead embosses a pattern thereon. In such aspects, detector 1660 can use dark-field illumination. An optical source shines light at the surface of receiver 42 at a very shallow angle, so that the light path is almost parallel to the face of receiver 42. A camera or other image sensor captures an image of the illuminated face of receiver 42, which includes extended shadows from any bumps or other non-flat features on receiver 42. A processor analyzes the image to locate the shadows and corresponding embossing marks.

In various aspects, detector 1660 includes an LED or laser range-finder used to sense embossed patterns. The range-finder scans a light source across receiver 42 and measures round-trip time-of-flight to determine the distance from the light source to the surface of receiver 42. These data can be processed to locate portions of receiver 42 that deviate from planar. In various aspects, detector 1660 includes a lever that drags on a surface of receiver 42 and moves when it rides over bumps or embossing marks. One end of the lever drags on, or rides across, receiver 42, and the position of the other end is sensed, e.g., with an encoder. The distance from the lever pivot to the drag end is preferably much less than the distance from the lever pivot to the sensing end. A mechanical or optical lever can be used.

In various aspects, detector 1660 can also detect failure to cut or otherwise puncture receiver 42 in ways other than perforating.

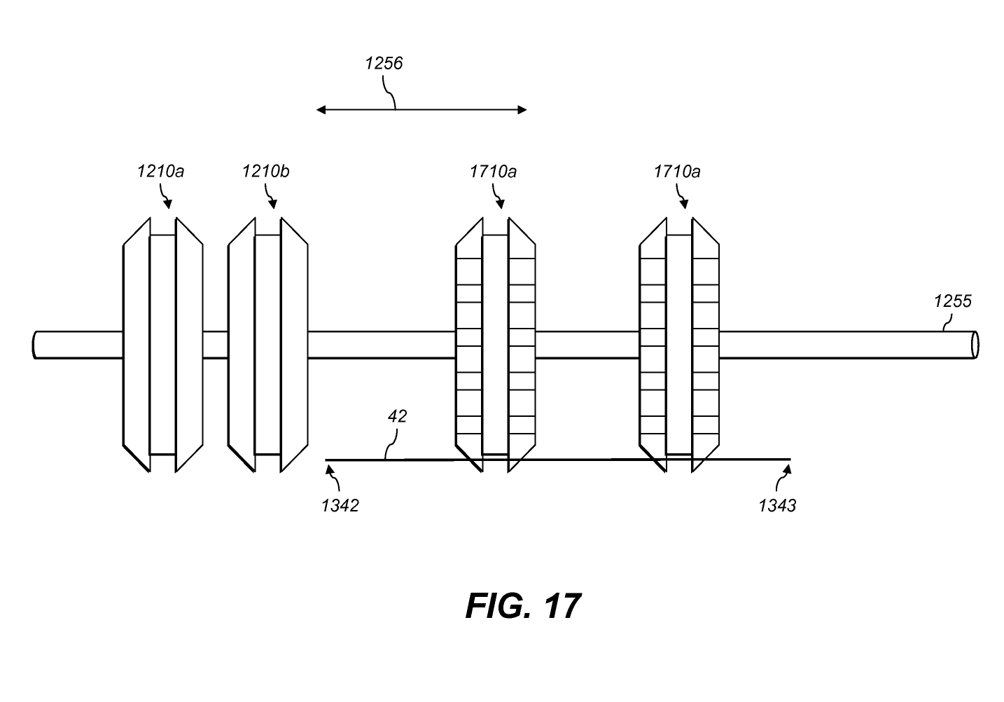

FIG. 17 shows portions of apparatus for selectively puncturing a moving receiver according to various aspects. Shaft 1255 extends beyond edges 1342, 1343 of receiver 42. Turret 1270 (FIG. 12) can be used or not. Puncturing devices 1210a, 1210b, 1710a, 1710b on shaft 1255 consist of one or more cutting devices (here, puncturing devices 1210a, 1210b) arranged adjacent to each other (and optionally spaced apart) along transport axis 1256; and one or more perforating devices (here, puncturing devices 1710a, 1710b, represented graphically with transverse marks on the perforating wheels) arranged adjacent to each other (and optionally spaced apart) along transport axis 1256. This permits changing between cutting and perforating by moving puncturing devices 1210a, 1210b, 1710a, 1710b laterally. Combinations of cuts and perforations can also be performed using this device, within the limitation that cuts and perforations cannot be intermixed without turret 1270. This device, used without turret 1270, advantageously provides flexible selections of cuts and perforations in a reduced volume of machinery. For example, the same printer can be used to produce perforated forms and cut photographs, and changes between the two can be accomplished quickly.

In various aspects, one of the puncturing devices 1210a, 1210b is a scoring device. The puncturing blades thereof are scoring blades in operative arrangement with pressure wheel thereof to score the moving receiver. One scoring blade or two scoring blades can be used. The scoring blades can be arranged in an interference fit with the pressure wheel, e.g., as shown in FIG. 9 by the dotted-line tips of perforating wheels 512. The pressure wheel can also include channels, e.g., V-channels, into which the scoring blade nests.

The invention is inclusive of combinations of the aspects described herein. References to “a particular aspect” and the like refer to features that are present in at least one aspect of the invention. Separate references to “an aspect” or “particular aspects” or the like do not necessarily refer to the same aspect or aspects; however, such aspects are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

### PARTS LIST

31, 32, 33, 34, 35 printing module
38 print image
39 fused image
40 supply unit
42, 42A, 42B receiver
50 transfer subsystem
60 fuser
62 fusing roller
64 pressure roller
66 fusing nip
68 release fluid application substation
69 output tray
70 finisher
81 transport web
86 cleaning station
99 logic and control unit (LCU)
100 printer
210, 210a, 210b, 210c, 210d,
210e, 210f, 210g cutting device
212 cutting wheel
214 pressure wheel
230 drive mechanism
231 motor
232 shaft
233 motor
234 shaft
242 feed direction
250 transport mechanism
251 area
252 pinion
253 motor
254 rack
261 job specification
270, 270a, 270b, 270c, 270d,
270e, 270f non-chad area
275a, 275b, 275c, 275d, 275e,
275f, 275g chad area
292 edge of the receiver
299 controller
404 chad
405 chad piece
410 friction member
414 nip
442 speed of the receiver
460 deflector
465 chad chopper
510, 510a, 510b perforating device
512 perforating wheel
514a, 514b, 514c protrusion
610a, 610j, 610x perforating device
612a, 612b, 612j, 612k, 612x, 612y perforating wheel
613x axis
701, 702 region
714 protrusion
811 perforations
812 puncturing wheel
813 axis
814 pressure wheel
815 axis
824 mating surface
899 perforations
919 backer member
919x shaft
961 job specification
970 non-chad area
975a, 975b chad area
1019 backer member
1030 drive mechanism
1042 width
1080 engagement device
1110 perforating device
1111 spring
1160 lever
1165 cam wheel
1177 bracket
1210a, 1210b perforating device
1212 puncturing wheel
1214 pressure wheel
1230 drive mechanism
1232 shaft
1234 shaft
1250 transport mechanism
1252 pinion
1253 motor
1254 rack
1255 shaft
1256 transport axis
1257 end
1261 job specification
1270 turret
1271, 1272 shaft segments
1277 actuator
1281, 1282 support
1299 controller
1310 puncturing device
1311, 1312, 1314, 1321, 1322,
1323, 1332, 1334 shaft segment
1342, 1343 edge of the receiver
1413, 1424 shaft segment
1504 chad
1560 deflector
1561 fixed end
1562 free end
1563 switch
1564 spring
1599 controller
1601, 1602, 1603, 1604 business-card area
1610 perforating device
1612 perforating wheel
1660 detector
1661 optical source
1662 optical detector
1710a, 1710b puncturing device
4159 circumferential speed

1. Apparatus for perforating a moving receiver comprising:
a backer member extending across a width of a sheet area;
a plurality of perforating devices, each comprising two parallel perforating wheels and an engagement device adapted to selectively press the perforating wheels towards the backer member in a first condition to define two perforating areas and a chad area arranged laterally between the plurality of perforating areas, or to selectively retract the perforating wheels from the backer member in a second condition;
a drive mechanism for rotating the backer member or the perforating wheels of two or more of the plurality of perforating devices so that the rotating perforating wheels engage the moving receiver to perforate the moving receiver parallel to its feed direction in the perforating areas, whereby one or more proto-chads are defined on the moving receiver;
a transport mechanism for selectively moving the plurality of perforating devices perpendicular to the feed direction of the moving receiver, and for controlling the respective engagement devices of each of the plurality of perforating devices; and
a controller for receiving a job specification including two or more specified perforation locations and causing the transport mechanism to:
operate the engagement devices of a selected two or more of the plurality of perforating devices in the second condition; then
laterally position the selected two or more perforating devices to perforate the moving receiver in the two or more specified perforation locations; then
operate the engagement devices of the selected two or more perforating devices in the first condition.

2. The apparatus according to claim 1, wherein the drive mechanism rotates the perforating wheels, the apparatus further comprising a shaft on which the perforating wheels are mounted and along which the transport mechanism selectively moves the perforating wheels.

3. The apparatus according to claim 2, wherein the shaft extends beyond the edge of the moving receiver and the transport mechanism is adapted to move at least one of the plurality of perforating devices beyond the edge of the moving receiver.

4. The apparatus according to claim 1, wherein the drive mechanism rotates the backer member.

5. The apparatus according to claim 1, further including a friction member disposed between the perforating wheels of one of the plurality of perforating devices and adapted to draw the moving receiver through the plurality of perforating devices.

6. The apparatus according to claim 5, wherein the friction member and the backer member form a nip through which the moving receiver is drawn.

7. The apparatus according to claim 6, wherein the friction member and the backer member have compliant surfaces.

8. The apparatus according to claim 1, wherein the backer member has a compliant surface.
